(19) United States
(12) Patent Application Publication
(10) Pub. No.: US 2009/0300473 A1
(43) Pub. Date: Dec. 3, 2009

(54) Systems and Methods for Displaying Albums Having Links to Documents

(76) Inventors: Randy Adams, Menlo Park, CA (US); Mark David Kvamme, Atherton, CA (US); John Lawrence Holland, JR., Berkeley, CA (US)

Correspondence Address: JONES DAY, 222 EAST 41ST ST, NEW YORK, NY, 10017, US

(21) Appl. No.: 12/142,759

(22) Filed: Jun. 19, 2008

Related U.S. Application Data
(63) Continuation-in-part of application No. 12/131,087, filed on May 31, 2008.

(51) Int. Cl. G06F 17/00

(52) U.S. Cl. 715/205

(57) ABSTRACT

Under one aspect, a method of displaying information includes: obtaining, responsive to a user query, an album from a remote computer, wherein the album comprises a plurality of links. Each link is to a static graphic representation, and each static graphic representation is stored in a document repository in a remote location. Each static graphic representation is a static graphic representation of a document retrieved from the Internet at a time before the obtaining. The method also includes getting, responsive to said user query, a subset or all of the static graphic representations using a corresponding subset or all of the links. The subset or all of the static graphic representations in the album is at least two static graphic representations in the album. The method also includes displaying the subset of static representations on a graphic output device.

### CROSS-REFERENCE TO RELATED APPLICATIONS

This application is a continuation-in-part, and claims the benefit under 35 U.S.C. §120, of U.S. patent application Ser. No. 12/131,087, filed May 31, 2008 and entitled “Systems and Methods for Visually Grouping Links to Documents,” the entire contents of which are incorporated by reference herein.

This application is also related to U.S. patent application Ser. No. (TBA), filed concurrently herewith and entitled “Systems and Methods for Building Albums Having Links to Documents,” the entire contents of which are incorporated by reference herein.

This application generally relates to information search and retrieval. More specifically, this application relates to grouping, sharing, and using static representations of selected web pages.

### BACKGROUND

Conventional web browsers, such as Internet Explorer, allow a user to bookmark links to web pages. The links are typically saved in nested folders, and the link to a given web page is identified by a title assigned to it either by the creator of the web page, or by the user. Although the user can create titles for different bookmark folders to make finding particular bookmarked (linked) web pages easier, a user wishing to view a particular page must rely on the titles given to the bookmarked web pages, often spread through several different folders, to find the title of the desired page. The text-based nature of this conventional bookmarking interface thus provides the user with only a limited amount of information for use in identifying which page is the one they want to view.

Such a limitation extends to the user's ability to share links of interest with others. For example, in Internet Explorer, if the user bookmarks a set of web pages about a certain topic, and wants to share those pages with others, the user can export the set of bookmarked web pages from the web browser into a file or other form of computer readable media, typically in the form of a stored web page. The user can then share this file or other form of computer readable media with others, e.g., via email. In the case of Internet Explorer, the exported set of bookmarked web pages includes the titles of the bookmarked web pages and links to the pages. To view the exported bookmarked pages once shared, other users must sequentially click the links to the pages.

Social networking websites such as del.icio.us are also text based, allowing a user to share a list of links to web pages of interest with others. Users can also share bookmarked web pages by copying links to those web pages into an e-mail to be sent to others. However, such social networking sites, like conventional web browsers, rely on text-based representation of the shared links, rather than graphical indications.

Given the drawbacks of conventional bookmarks, what is needed in the art are improved systems and methods for grouping links to selected webpages, and sharing and using such groups of links.

### BRIEF SUMMARY

The shortcomings in the prior art are addressed. Groups of links to web pages are collected into albums. The albums are shared with other users. When an album is viewed, the actual web pages, or static graphic representations of the web pages, in the album are graphically presented. By sharing the contents of the web pages in an album in this way, rather than cryptic title information, relevant links in the album can be found faster and more easily than conventional methods.

In an advantageous application of the albums, the links to web pages are built using a document index or vertical collection index in which each web page or static graphic representation in the index or vertical collection has been categorized using classifiers and training document sets. Thus, when a user builds an album, the category of each web page or static graphic representation linked by the album is known. Albums themselves can therefore be categorized based on the category of the individual web pages or static graphic representations that are linked by the album. Directed advertising applications are therefore possible, in which advertisements or interactive widgets that provide an interactive advertisement are inserted into albums or served with albums when albums are viewed, shared, or edited.

Under one aspect, a method of using the content of web pages to provide a user with additional information includes (i) obtaining an album of web pages, the album of web pages including references to a plurality of web pages, (ii) characterizing content of the web pages referred to in the album, (iii) based on the characterization, identifying a topic of interest to the user, (iv) displaying static representations of the web pages referred to in the album on a graphic output device, and (v) displaying additional information relating to the topic of interest on the graphic output device. In some embodiments, the album of web pages includes a markup language document. In some embodiments, the markup language document includes an entry for each web page referred to in the album, each entry including an Internet address for the corresponding web page. In some embodiments, the content of the web pages referred to in the album is characterized by identifying one or more vertical collections to which the web pages referred to in the album belong. In some embodiments, the content of the web pages referred to in the album is characterized based on a category of the album. In some embodiments, the category of the album is assigned based on user input. In some embodiments, the category of the album is assigned automatically based on a vertical collection to which a web page in the album belongs. In some embodiments, the content of the web pages referred to in the album is characterized based on a frequency of words used in the web pages. In some embodiments, the content of the web pages referred to in the album is characterized based on a popularity of a web page referred to in the album. In some embodiments, the displaying the additional information relating to the topic of interest includes interleaving an image containing the additional information among the static representations of the web pages referred to in the album. In some embodiments, the displaying the additional information relating to the topic of interest includes displaying an image containing the additional information behind the static representations of the web pages referred to in the album. In some embodiments, the displaying the additional information relating to the topic of interest includes displaying text adjacent the static representations of the web pages referred to in the album. In some embodiments, the displaying the additional information relating to the topic of interest includes displaying an album button representing an album pertaining to that topic. In some embodiments, the displaying the additional information relating to the topic of interest includes displaying a widget pertaining to that topic. In some embodiments, the additional information relating to the topic of interest includes an image of a web page pertaining to that topic. In some embodiments, the additional information relating to the topic of interest includes an advertisement pertaining to that topic.

Another aspect provides a computer program product for use in conjunction with a computer system, the computer program product including a computer readable storage medium and a computer program mechanism embedded therein, the computer program mechanism including instructions that encode and of the methods disclosed herein. Another aspect provides a computer, including a main memory and one or more processor; and one or more programs, stored in the main memory and executed by the one or more processor, wherein the one or more programs collectively including instructions for carrying out any of the methods disclosed herein.

Under another aspect, a method of displaying information includes: obtaining, responsive to a user query, an album from a remote computer, wherein the album includes a plurality of links, each link in the plurality of links is to a static graphic representation in a plurality of static graphic representations, each static graphic representation in the plurality of static graphic representations is stored in a document repository in a remote location; each static graphic representation in the plurality of static graphic representations is a static graphic representation of a document retrieved from the Internet at a time before the obtaining; getting, responsive to said user query, a subset or all of the static graphic representations in the plurality of static graphic representations using a corresponding subset or all of links in the plurality of links, wherein the subset or all of the static graphic representations in the album is at least two static graphic representations in the album; and displaying the subset of static representations on a graphic output device.

In some embodiments, the displaying further includes displaying the subset of static graphic representations in an order specified by the album. In some embodiments, the user query identifies the album from among a plurality of albums. In some embodiments, the user query is one of: an email including a link identifying the album, a user clicking on a link in a web page, the link identifying the album. In some embodiments, the displaying includes displaying a first static graphic representation of a first document at a center position of the graphic output device, and displaying a second static graphic representation of a second document at an off-center position of the graphic output device, wherein the second static graphic representation is displayed rotated about a first axis of rotation that lies between the center position and the off-center position of the graphic output device. Some embodiments further include receiving user input shifting the second static graphic representation to the center position of the graphic output device. In some embodiments, each document in the plurality of documents is a web page obtained from the Internet before the obtaining, each static graphic representation in the plurality of static graphic representations includes a link to the corresponding document in the plurality of documents, and the displaying further includes displaying a live version of a web page corresponding to a displayed static graphic representation in the displayed subset of static graphic representations, responsive to a user selection of the static graphic representation that corresponds to the web page. In some embodiments, the album includes a markup language file. In some embodiments, the markup language file includes an entry for each link in the plurality of links.

Under another aspect, a computer program product for use in conjunction with a computer system includes a computer readable storage medium and a computer program mechanism embedded therein, the computer program mechanism including: instructions for obtaining, responsive to a user query, an album from a remote computer, wherein the album includes a plurality of links, each link in the plurality of links is to a static graphic representation in a plurality of static graphic representations, each static graphic representation in the plurality of static graphic representations is stored in a document repository in a remote location; each static graphic representation in the plurality of static graphic representations is a static graphic representation of a document retrieved from the Internet at a time before the obtaining; instructions for getting, responsive to said user query, a subset or all of the static graphic representations in the plurality of static graphic representations using a corresponding subset or all of links in the plurality of links, wherein the subset or all of the static graphic representations in the album is at least two static graphic representations in the album; and instructions for displaying the subset of static representations on a graphic output device.

Under another aspect, a computer includes a main memory; one or more processors; and one or more programs, stored in the main memory and executed by the one or more processors, the one or more programs collectively including instructions for: obtaining, responsive to a user query, an album from a remote computer, wherein the album includes a plurality of links, each link in the plurality of links is to a static graphic representation in a plurality of static graphic representations, each static graphic representation in the plurality of static graphic representations is stored in a document repository in a remote location; each static graphic representation in the plurality of static graphic representations is a static graphic representation of a document retrieved from the Internet at a time before the obtaining; getting, responsive to said user query, a subset or all of the static graphic representations in the plurality of static graphic representations using a corresponding subset or all of the links in the plurality of links, wherein the subset or all of the static graphic representations in the album is at least two static graphic representations in the album; and displaying the subset of static representations on a graphic output device.

Under another aspect, a method of sharing information about a plurality of web pages includes obtaining an album, the album including links to a plurality of web pages; transmitting the album to a second user in response to input from a first user; and performing the method, responsive to input from the second user, including: obtaining a static graphic representation of each web page in the plurality of web pages in the album, thereby retrieving a plurality of static graphic representations, wherein the plurality of static graphic representations were rendered from said corresponding plurality of web pages at a time before the obtaining; and displaying the plurality of static graphic representations on a graphic output device.

In some embodiments, transmitting includes: generating a computer-readable link to a location of the album on a remote computer; and electronically communicating the computer readable link to the location of the album to the second user. Some embodiments further include generating an icon representative of the album; and associating the computer-readable link with the icon such that each static graphic representation linked by the album is displayed on the graphic output device responsive to user selection of the icon. In some embodiments, the electronically communicating includes emailing the computer readable link to the album to the second user. In some embodiments, the electronically communicating includes posting the computer readable link to the album on a web site that is accessible to the second user. In some embodiments, the album is modifiable by the second user. In some embodiments, the album includes a markup language document. In some embodiments, the markup language document includes an entry for each web page referred to in the album, each entry including an Internet address for the corresponding web page.

Under another aspect, a computer program product for use in conjunction with a computer system includes a computer readable storage medium and a computer program mechanism embedded therein, the computer program mechanism including: instructions for obtaining an album, the album including links to a plurality of web pages; instructions for transmitting the album to a second user in response to input from a first user; and instructions for performing the method, responsive to input from the second user, including: obtaining a static graphic representation of each web page in the plurality of web pages in the album, thereby retrieving a plurality of static graphic representations, wherein the plurality of static graphic representations were rendered from said corresponding plurality of web pages at a time before the obtaining; and displaying the plurality of static graphic representations on a graphic output device.

Under another aspect, a computer includes: a main memory; one or more processors; and one or more programs, stored in the main memory and executed by the one or more processors, the one or more programs collectively including instructions for: obtaining an album, the album including links to a plurality of web pages; transmitting the album to a second user in response to input from a first user; and performing the method, responsive to input from the second user, including: obtaining a static graphic representation of each web page in the plurality of web pages in the album, thereby retrieving a plurality of static graphic representations, wherein the plurality of static graphic representations were rendered from said corresponding plurality of web pages at a time before the obtaining; and displaying the plurality of static graphic representations on a graphic output device.

### BRIEF DESCRIPTION OF THE SEVERAL VIEWS OF THE DRAWING

FIG. 1A illustrates a method of visually grouping links to web pages and/or links to static graphic representations of web pages into albums, according to some embodiments.

FIGS. 1B-1C illustrate a system for allowing users to create and share albums and for providing users with additional information based on those albums, according to some embodiments.

FIG. 1D illustrates a data structure for storing albums, according to some embodiments.

FIGS. 2A-2C illustrate an interface allowing users to create an album and/or add links to web pages and/or links to static graphic representations of web pages to an existing album, according to some embodiments.

FIG. 3 illustrates the text of an exemplary extensible markup language (XML) document for storing links to web pages and/or links to static graphic representations of web pages in an album, according to some embodiments.

FIG. 4 illustrates a method of displaying the web pages or static graphic representation of web pages that are references by an album, according to some embodiments.

FIGS. 5A-5G illustrate interfaces allowing users to edit, view, and share an album according to some embodiments.

FIG. 6 illustrates a method of providing users with additional information based on the content of an album according to some embodiments.

FIG. 7 illustrates the architecture of a vertical index, according to some embodiments.

Like reference numerals refer to corresponding parts throughout the several views of the drawings.

### DETAILED DESCRIPTION

### 1. Overview

Embodiments of the invention provide systems and methods for visually grouping links to selected web page renderings or web sites into albums, and sharing and using such albums are provided.

Specifically, embodiments of the invention allow a user to visually aggregate or compile links to web pages and/or web page renderings into groups that are referred to herein as albums. In some embodiments, the album is displayed analogously to an album of pieces of paper, in which each respective displayed page of the album is for a corresponding link in the album and the respective page displays the static graphic representation of a web page or a web page referenced by the link. The user can create a plurality of albums, each containing one or more links to web pages and/or links to static graphic representations from web pages. In some embodiments, albums are categorized without human intervention according to the subject matter of the web pages and/or static graphic representations that the albums link. In some embodiments albums are categorized by anyone having read/write privileges to the album. The album pages can be reviewed by “flipping” through the different pages represented by the album. In some embodiments, the user can select a particular web page that is represented by static rendering in the album by selecting the static graphic representation.

Some embodiments of the invention allow the user to readily share such albums with others in a visual, intuitive format. For example, the user can share an album using an interface that generates an email, or other form of electronic form of communication such as a file, that includes a link to an album. The user can electronically share the link to one or more recipients (e.g., through E-mail, file sharing, etc.), typically over a network connection such as the Internet. The one or more recipients can view the album by using a web browser to open the link sent by the user. In another example of the distribution of an album, a user can post an album to a blog or other web page using an interface that, for example, embeds a link to the album within that blog or web page. The album is displayed to visitors to the blog or web page when they activate the link, allowing them to flip through the pages of the album. The shared albums are visual in nature thus facilitating the advantageous visual review of static graphic representations of web pages, or web pages linked by the album.

Some embodiments of the invention also use information about links to web pages or links to static graphic representations in an album in order to provide the album user with additional information that may be useful. For example, the album user may have grouped links to static graphic representations of web page into an album based on a particular subject, e.g., “cars.” This information can be used to provide the user with links to additional web pages that may be of interest to the user, and/or to provide targeted advertising to the user. For example, when a user has expressed an interest in cars, the user may find it helpful to be provided with links to additional popular web pages that relate to cars, or advertisements that relate to cars. Some different options for integrating such additional links and/or targeted advertising into albums being displayed to the user are described in greater detail below.

First methods and systems for generating, storing, displaying, and modifying albums will be described. Then, sharing albums over the Internet or other form of network will be described. Finally, using albums to provide users with additional information, such as directed advertisements will be described.

### 2. Systems and Methods for Generating, Storing, Displaying, and Modifying Albums

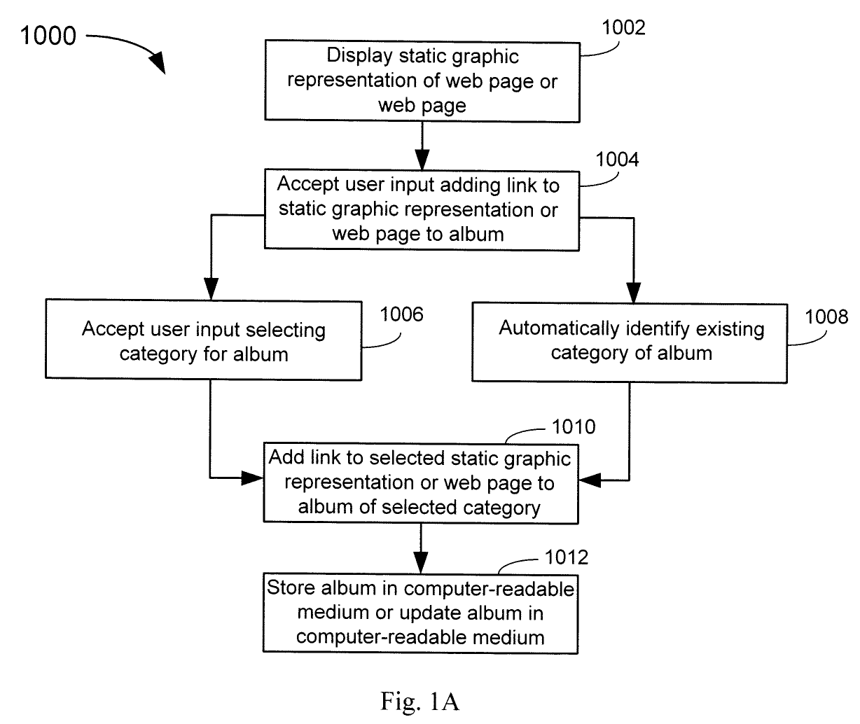

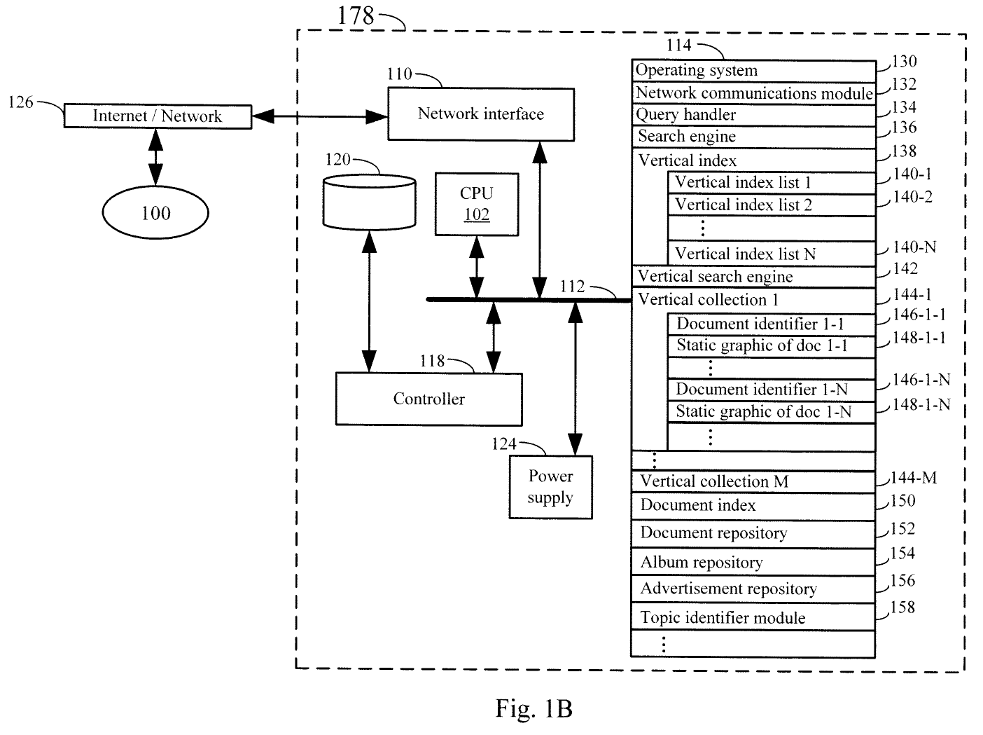

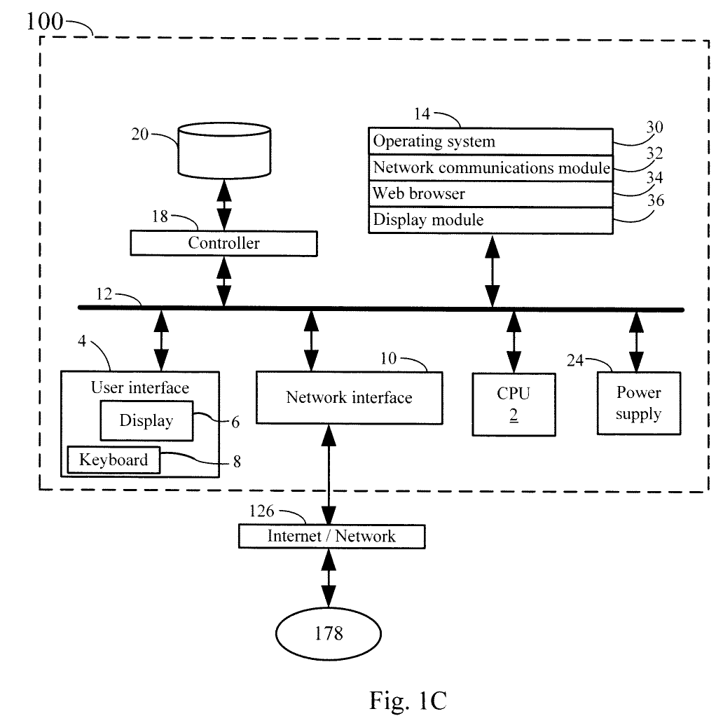

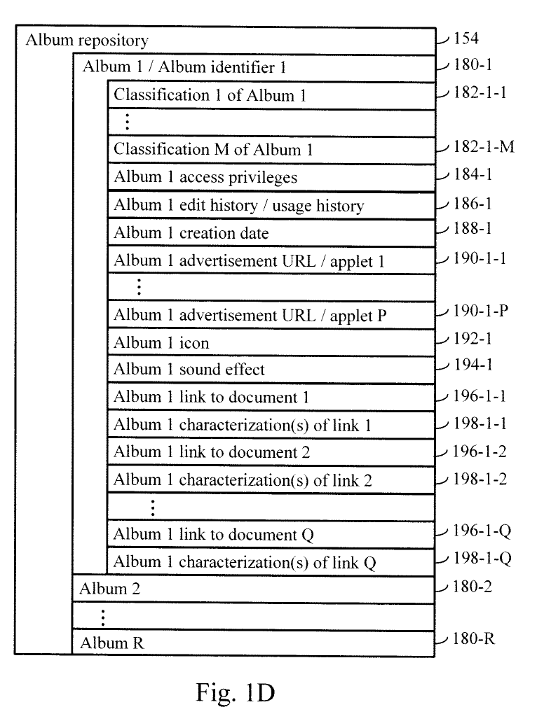

FIG. 1A is an illustrative method 1000 of visually grouping links to static graphic representations of web pages and/or links to web pages into albums. In some embodiments, a web page or a static graphic representation of a web page is displayed to a user (1002). In one example, the web page or a static graphic representation of a web page is displayed to the user as a result of the user performing a search of a document index or other corpus of documents. In another example, in the case of web pages, the web page is displayed to the user when the user is accessing a popular web site hosted by YOUTUBE®, FLICKR®, or the like. In some embodiments, an album contains links to some web pages and links to some static graphic representations of other web pages. In some embodiments, an album contains links to web pages and no links to static graphic representations of web pages. In some embodiments, an album contains links to static graphic representations of web pages but no direct links to web pages. In some embodiments, all the source web pages and/or source static graphic representations that are linked by a given album are contained in or addressable by a document index controlled by a document index administrator. In some embodiments, all the graphic representations that are linked by a given album are contained in or addressable by a document index controlled by a document index administrator but all the web pages that are linked by the given album are at URLs not under the control of the document index administrator (e.g., are at URLs in the Internet).

As noted above, an album may contain links to static graphic representations. In some embodiments, static graphic representations are generated using a web browser for which source code is available, such as MOZILLA® FIREFOX®, in which an extension is added that extracts a static graphic representation of a web page. Typically, such generation of a static graphic representation is performed as part of a generalized index of a large corpus of documents retrieved from the Internet, an internet, or some other defined set of documents. As used herein, a static graphic representation of a web page can be an image of the rendered web page at a given instant in time or a time averaged representation of the web page over a period of time (e.g., one second or more, ten seconds or more, a minute or more, two minutes or more, etc.). Thus, a static graphic representation fully encompasses dynamic web pages that include applets such as ticker tapes or other dynamic components that cause the representation of the web page to change over time. Any dynamic components in a web page can either be ignored when constructing the static graphic representation of the web page, averaged over a period of time when constructing the static graphic representation of the web page, or a snapshot of such dynamic components (e.g., snapshots) can be used for the purposes of constructing the static graphic representation of the web page.

Returning to FIG. 1A, user input is accepted indicating that the user wishes to add the link to the displayed web page or displayed static graphic representation to an album (1004). For example, the user may select a particular button with a mouse click, or may enter one or more predetermined keystrokes, or may drag and drop the web page or static representation of the web page into a predefined area of the screen that represents the user's intent to add a link to the web page or static graphic representation of the website to an album.

As described in greater detail below, in some embodiments it is advantageous to categorize an album, both so that the user can later readily recognize a common attribute of the static graphic representations and/or web pages linked by the album, and so that additional information based on such album content can be provided to the user. Accordingly, in some embodiments, the user selects the album category (1006), for example by designating a new category for the album, or otherwise indicating a desired category name for the category, to which the user wants to add the link selected in step 1004. In alternative embodiments, the album category is automatically selected (1008), for example, based on a predetermined category of the web page or static graphic representation that the user has indicated is to be added to the album.

In step 1010, a link to the selected static graphic representation of a web page or a web page is then added to the album of the category selected in alternative steps 1006/1008. In instances where such an album did not previously exist, a new album is created, and the link constitutes the only link in that album. Other static graphic representations can subsequently be added to the album. In instances where such an album did previously exist, the link is added to the list of links that is already in the album. An album can have any number of links to static graphic representations and/or links, for example, between 1 and 1,000,000, and all numbers in between. Advantageously, as described in further detail below, in preferred embodiments, only a link to the static graphic representation of a web page or a link to a web page is added to the album. The static graphic representations or web pages themselves are not stored in the album. In some embodiments the static graphic representations or web pages are stored in a controlled location on a computer system that is remote to the computer system being used by the user. In this way, a system administrator has control over the static graphic representations and web pages themselves. In some embodiments, the static graphic representations are stored in a controlled location but the web pages are in their native locations (URLs) in the Internet. As disclosed in further detail below, such embodiments provide unique advantages to the system administrator for purposes such as directed advertising in instances where the category of the album, or each of the static graphic representations or web pages linked to the album is known.

Continuing with FIG. 1A, the album is stored on a computer-readable medium in a data structure such as a database for future use (1012). The album comprises links to static graphic representations and/or web pages either selected by the user or automatically generated by a program. The album can be stored locally, e.g., on the computer that a user uses to browse the web, or can be stored remotely, e.g., on a remote server that a user can access by visiting a particular web page. In one embodiment, the album is stored (locally or remotely) as a set of links to the web pages or static graphic representations in the album, and the web pages and the static graphic representation of the web pages in the album are stored remotely in a database. When the album is viewed, the static graphic representation of the web pages or the web pages are obtained from the remote database and displayed so that the user can browse among them. In some embodiments, when viewing a select static graphic representation, the user can opt to load a fresh image of the source URL that contains the document that was used to render the select static graphic representation.

FIGS. 1B, 1C, and 1D illustrate systems and data structures for generating, editing, sharing, storing, and using albums in association with a search engine. Of course, there is no requirement that the content (e.g., web pages, static graphic representations of web pages, etc.) that is linked by an album be from search engine search results. Such content can be obtained while reviewing a specific web site that was not obtained using a search engine. However, for the purposes of describing one computer-based implementation of the present invention, a computer system that provides a search engine feature will be described. It will be understood that the present invention imposes no requirement that a search engine be provided, or any data structures associated with a search engine.

Specifically, FIG. 1B illustrates an embodiment of a server 178 that includes albums functionality, and FIG. 1C illustrates an embodiment of a client 100 that includes albums functionality. In some embodiments, server 178 and/or client 100 are each implemented using one or more (not shown) computers. Referring to FIG. 1B, server 178 has one or more processing units (CPUs) 102, a network or other communications interface 110, a memory 114, one or more magnetic disk storage devices 120 accessed by one or more controllers 118, one or more communication busses 112 for interconnecting the aforementioned components, and a power supply 124 for powering the aforementioned components. Data in memory 114 can be seamlessly shared with non-volatile memory 120 using known computing techniques such as caching. Memory 114 and/or memory 120 can include mass storage that is remotely located with respect to the central processing unit(s) 102. In other words, some data stored in memory 114 and/or memory 120 may in fact be hosted on computers that are external to server 178 but that can be electronically accessed by server 178 over an Internet, intranet, or other form of network or electronic cable (illustrated as element 126 in FIGS. 1B and 1C) using network interface 110.

Server 178 is connected via Internet/network 126 to one or more client devices 100. FIGS. 1B and 1C illustrate the connection to only one such client computer 100. However, in practice, server 178 can be connected to 10 or more different client devices 100, or 100 or more client devices 100, or 1000 or more client devices 100, or 10,000 or more client devices 100, and more typically still, 100,000 or more of the client devices 100. It will be appreciated by those of skill in the art that server 178 may in fact have a computer architecture that is more complex than that shown in FIG. 1B. For instance, a front end set of servers may be used to receive and distribute search queries from numerous client 100s among a set of back-end servers that actually process the search queries. In such a system, server 178 as shown in FIG. 1B would be one such back-end server.

In some embodiments, memory 114 stores:
an operating system 130 that includes procedures for handling various basic system services and for performing hardware dependent tasks;
a network communication module 132 that is used for connecting server 178 to various client computers such as client computers 100 (FIG. 1B) and possibly to other servers or computers via one or more communication networks, such as the Internet, other wide area networks, local area networks (e.g., a local wireless network can connect the client computers 100 to server 178), metropolitan area networks, and so on;
an optional query handler 134 for receiving a search query from a client computer 100;
an optional search engine 136 for searching either a selected optional vertical collection 144 or a document index 150, where document index 150 can, for example, represent the entire Internet or an intranet, for documents related to a search query and for forming a groups of web pages or ranked documents of static graphic representations that are related to the search query;
an optional vertical index 138 including a plurality of vertical index lists 140, where each vertical index list is an index of a corresponding vertical collection 144;
an optional vertical search engine 142, for searching optional vertical index 138 for one or more vertical index lists 140 that are relevant to a given search query;
an optional plurality of vertical collections 144, each optional vertical collection 144 including a plurality of document identifiers 146 and, for each respective document identifier 146, a static graphic representation 148 of the source URL for the document represented by the respective document identifier 146;
an optional document index 150 including a list of terms, a document identifier uniquely identifying each document associated with terms in the list of terms, and the sources of these documents;
a document repository 152 including a source URL or a reference to a source URL for each document in the document repository and (ii) an optional static graphic representation of the source URL for each document in the document repository;
an album repository 154 including a plurality of albums;
an advertisement repository 156 including a plurality of advertisements categorized by topic; and
a topic identifier module 158 that is used for identifying topics of interest to users based on albums stored in the album repository 154 and/or a characterization of web pages or static graphic representations of web pages linked by such albums.

The optional search indexing features of server 178 are discussed below in the section entitled “Search engine embodiments.” In some embodiments, a static graphic representation of a web page is a bitmapped or pixmapped image of the web page. As used herein, a bitmap or pixmap is a type of memory organization or image file format or data structure used to store a digital image. A bitmap is a map of bits, a spatially mapped array of bits. Bitmaps and pixmaps refer to the similar concept of a spatially mapped array of pixels. Raster images in general may be referred to as bitmaps or pixmaps. In some embodiments, the term bitmap implies one bit per pixel, while a pixmap is used for images with multiple bits per pixel. One example of a bitmap is a specific format used in WINDOWS® that is usually named with the file extension of .BMP (or .DIB for device-independent bitmap). Besides BMP, other file formats that store literal bitmaps include InterLeaved Bitmap (ILBM), Portable Bitmap (PBM), X Bitmap (XBM), and Wireless Application Protocol Bitmap (WBMP). In addition to such uncompressed formats, as used herein, the term bitmap and pixmap refers to compressed formats. Examples of such bitmap formats include, but are not limited to, formats such as JPEG, TIFF, PNG, and GIF, to name just a few, in which the bitmap image, as opposed to the vector image, is stored in a compressed format. JPEG is usually lossy compression. TIFF is usually either uncompressed, or losslessly Lempel-Ziv-Welch compressed like GIF. PNG uses deflate lossless compression, another Lempel-Ziv variant. More disclosure on bitmap images is found in Foley, 1995, Computer Graphics: Principles and Practice, Addison-Wesley Professional, p. 13, ISBN 0201848406 as well as Pachghare, 2005, Comprehensive Computer Graphics: Including C++, Laxmi Publications, p. 93, ISBN 8170081858, each of which is hereby incorporated by reference herein in its entirety.

In typical uncompressed bitmaps, image pixels are generally stored with a color depth of 1, 4, 8, 16, 24, 32, 48, or 64 bits per pixel. Pixels of 8 bits and fewer can represent either grayscale or indexed color. An alpha channel, for transparency, may be stored in a separate bitmap, where it is similar to a grayscale bitmap, or in a fourth channel that, for example, converts 24-bit images to 32 bits per pixel. The bits representing the bitmap pixels may be packed or unpacked (spaced out to byte or word boundaries), depending on the format. Depending on the color depth, a pixel in the picture will occupy at least n/8 bytes, where n is the bit depth since 1 byte equals 8 bits. For an uncompressed, packed within rows, bitmap, such as is stored in Microsoft DIB or BMP file format, or in uncompressed TIFF format, the approximate size for a n-bit-per-pixel (2ⁿ colors) bitmap, in bytes, can be calculated as: size≈width×height×n/8, where height and width are given in pixels. In this formula, header size and color palette size, if any, are not included. Due to effects of row padding to align each row start to a storage unit boundary such as a word, additional bytes may be needed.

In some embodiments, the static graphic representation is generated using a web browser for which source code is available, such as MOZILLA® FIREFOX®. A static graphic representation of a web page can be an image of the rendered web page at a given instant in time or a time averaged representation of the web page over a period of time (e.g., one second or more, ten seconds or more, a minute or more, two minutes or more, etc.). Thus, a static graphic representation fully encompasses dynamic web pages that include applets such as ticker tapes or other dynamic components that cause the representation of the web page to change over time. Any dynamic components in a web page can either be ignored when constructing the word map for the document encoding the web page, averaged over a period of time, or a snapshot of such dynamic components (e.g., snapshots) can be used for the purposes of constructing the static graphic representation of the web page.

Referring to FIG. 1C, in typical embodiments, a client device 100 includes:
one or more processing units (CPUs) 2;
a network or other communications interface 10;
a memory 14;
optionally, one or more magnetic disk storage devices 20 accessed by one or more optional controllers 18;
a user interface 4, the user interface 4 including a display 6 and a keyboard or other input device 8;
one or more communication busses 12 for interconnecting the aforementioned components; and
a power supply 24 for powering the aforementioned components.

In some embodiments, data in memory 14 can be seamlessly shared with non-volatile memory 20 using known computing techniques such as caching. In some embodiments the client device 100 does not have a magnetic disk storage device. For instance, in some embodiments, the client device 100 is a portable handheld computing device and network interface 10 communicates with Internet/network 126 by wireless means.

In some embodiments, memory 14 stores:
an operating system 30 that includes procedures for handling various basic system services and for performing hardware dependent tasks;
a network communication module 32 that is used for connecting client device 100 to server 178 and/or the Internet or other network;
a web browser 34 for viewing albums, web pages, and static graphic representations on client computer 100; and
a display module 36 for instructing the web browser 34 on how to display albums and optional search results relevant to a submitted search query.

In some embodiments, the display module 36 is a plugin to the web browser 34. For example, in some embodiments, display module 36 is a plugin that relies on the ADOBE® Flash Player version 9 or equivalent functionality. Thus, in some embodiments, memory 14 further includes ADOBE® Flash Player version 9 or equivalent functionality (not shown).

In some embodiments, albums created by several different users of the system depicted in FIGS. 1B and 1C (server 178 and one or more clients 100 connected through Internet/network 126) are stored in album repository 154.
An exemplary album repository 154 is illustrated in FIG. 1D. Typically, what is shared by a user is a link to an album. The link to the album contains sufficient information to locate the corresponding album in album repository 154. For example, the link may simply be the value of an identifier 180 that uniquely identifies the album 180. To retrieve an album, the link to the album in the album repository 154 is used to retrieve the album. Then, the links in the album are used to retrieve individual web sites or static graphic representations represented by the web sites for display. Advantageously, in some embodiments, each album 180 has one or more classifications 182. Such classifications can be, for example, the classifications of the vertical collections 144 that contain documents that are linked by the album 180. For example, consider the case in which there is a particular web page is in a vertical collection 144 and a link to this web page is in an album 180. In this example, the characteristics of the vertical collection 144 containing the web page can be used to classify the album 180, and this classification can be stored as a classification 182 of the album 180. An album can have many classifications, for example, it can have the classification “cell phones,” “electronics,” and “not consumer complaints.”

In some embodiments there are public albums 180 that can be viewed by everyone and there are private albums 180 that can only be viewed by select users or select programs. In some embodiments, all albums are public meaning that they can be viewed by everyone, but only the creator of the album can has edit privileges. These are all examples of access privileges 184 that are stored in the album 180 in some embodiments. In some embodiments, access privileges 184 specify who can review the album 180, add or delete “pages” in the album 180, share the album 180, print the album 180, delete the album 180, copy the album 180, and annotate album pages. In some embodiments, rather than having album privileges 184, there are multiple identifiers to a given album, where the actually identity of identifier indicates the access privileges. Thus, if a first identifier to a given album 180 is shared, the recipient of the identifier can only view the album 180, whereas if a second identifier to a given album 180 is shared, the recipient of the identifier has full privileges to the album 180, including the right to modify, share, print, delete, or copy the album. In some embodiments, all users have the right to share and copy an album 180 so that albums become widely distributed across a broad user group. As described herein, in some embodiments, to share an album 180, all that is required is to share the album 180 identifier with one or more recipients.

Advantageously, in some embodiments, albums 180 contain an edit history 186 that indicates the last date in which an album was edited. In some embodiments, edit history 186 is a comprehensive edit history that indicates (i) when each link to a web page or static graphic representation was added to the album, (ii) who added the link to the album, (iii) whether any links were deleted from the album and, if so, the links that were deleted, (iv) how many times the album has been accessed, (v) who has accessed the album, (vi) when was the last time the album was accessed, and/or (vii) how many times the album has been shared. Edit history 184 can contain any combination of such information or any other information that relates to the modifications or usage history of album 180.

In some embodiments, the creation date 188 of an album 180 is stored in the album. In some embodiments, the creation date 188 is not stored and in some embodiments the creation date is simply stored as edit history information 186. In some embodiments, based on one or more of the classifications 182 of an album 180, album edit history and/or usage history 186, creating date 188, an identity or characteristic of any combination of the web pages or static graphic representations linked by the album 180, or any other information associated with the album and/or stored in the album, selected advertisements are associated with the album 180. In some embodiments, these advertisements 190 are stored in the album 180 itself. In some embodiments, advertisements 190 are links to advertisements that are stored in a separate optional advertisement repository 156. In some embodiments, advertisements 190 are not stored in album 180 but rather, whenever an album is viewed some combination of on one or more of the classifications 182 of the album 180, the album edit history and/or usage history 186, the album creation date 188, an identity or characteristic of any combination of the web pages or static graphic representations linked by the album 180, or any other information associated with the album and/or stored in the album is sent to a software module (e.g., an advertisement module) in or electronically accessible to server 178 that manages advertisement repository 156. Based on the information sent to the software module one or more appropriate advertisements are pulled from the advertisement module 156 and either integrated directly into the album 180 as separate pages of the album or are displayed along with the album 180 when the album is being viewed (e.g., as background, as a side panel, in a pop-window etc.). In some embodiments the advertisement is an interactive widget, such as a query form for a retailer that allows a user to enter information, such as billing information, and order products. Thus, in some embodiments, advertisements 190 are temporarily integrated into an album and displayed only once. In other embodiments, advertisements 190 are integrated into an album and persist in the album for a finite number of views. For example in some embodiments, an advertisement 190 is integrated into an album without human intervention and persists in the album 180 until the page in the album 180 containing the advertisement has been viewed a predetermined number of times (e.g., between one and ten times, more than once, more than five times, more than 100 times) or by a predetermined number of different album recipients (e.g., between one and ten album recipients, more than one album recipient, more than five album recipients, more than 100 album recipients). In some embodiments, an advertisement 190 persists permanently within an album (either directly or as link to the album). In some embodiments, an advertisement 190 persists within an album (either directly or as link to the album) for a predetermined period of time (e.g., for an hour or less, between one and five hours, for ten hours or less, for a number of days, for a month or less, etc.).

In some embodiments, the amount of money paid by an advertiser to host an advertisement 190 in an album is a function of the popularity of an album 180 as determined by any kind of metric such as, for example, how often an album is shared, how many times the album has been shared, the classification 182 of the album, the characterization of any of the links contained in the album 182, an identity of the person that created the album, or simply based upon agreed upon price.

Continuing to refer to FIG. 1D, in some embodiments, when an album 180 is shared (e.g., in a blog entry, by E-mail, in web posting, etc.) an icon is graphically displayed that gives an indication of the contents of the album. In some embodiments, this icon is stored as icon 192 in the album 180. In some embodiments, the icon 192 is a scaled down representation of the web page or static graphic representation of the first link in the album 180. In some embodiments, the icon 192 is a graphic representation of an album 180 classification 182. Likewise, in some embodiments when an album 180 is shared (e.g., in a blog entry, by E-mail, in web posting, etc.) a sound effect (e.g., a clip of a song, a distinct ring tone, etc.) is sound to announce the invitation to view the album 180. In some embodiments, the sound is stored as sound effect 194 in the album 180. In some embodiments the icon 192 and/or sound effect 194 are, in fact, advertisements. In such embodiments, advertisers pay to have certain icons 192 and/or sound effects 194 associated with albums 180.

An album contains one or more links 196, where each link 196 uniquely identifies a static graphic representation of a document such as a web page, or a static graphic representation of a document such as a web page. In some embodiments the source documents (e.g., web pages, static graphic representations, etc.) is stored or indexed by vertical index 138, vertical collections 144, document index 150 and/or document repository. In some embodiments an album 180 contains links to actual URLs on the Internet. In some embodiments, the characterization of each document referenced by an album 180 is known and such characterizations 198 are associated with their corresponding links in album 180 and stored in the album 180.

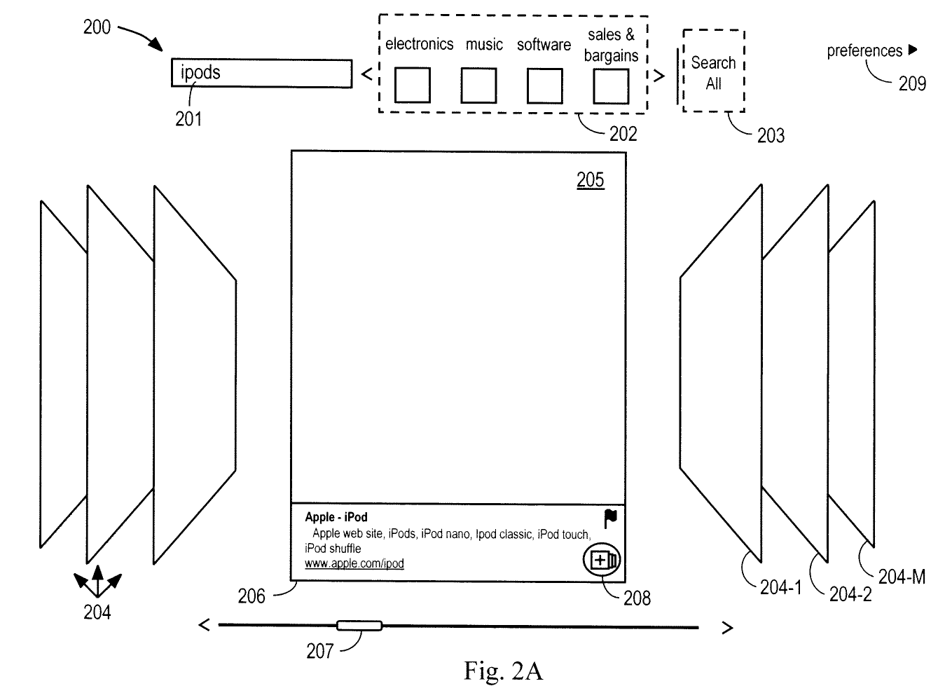

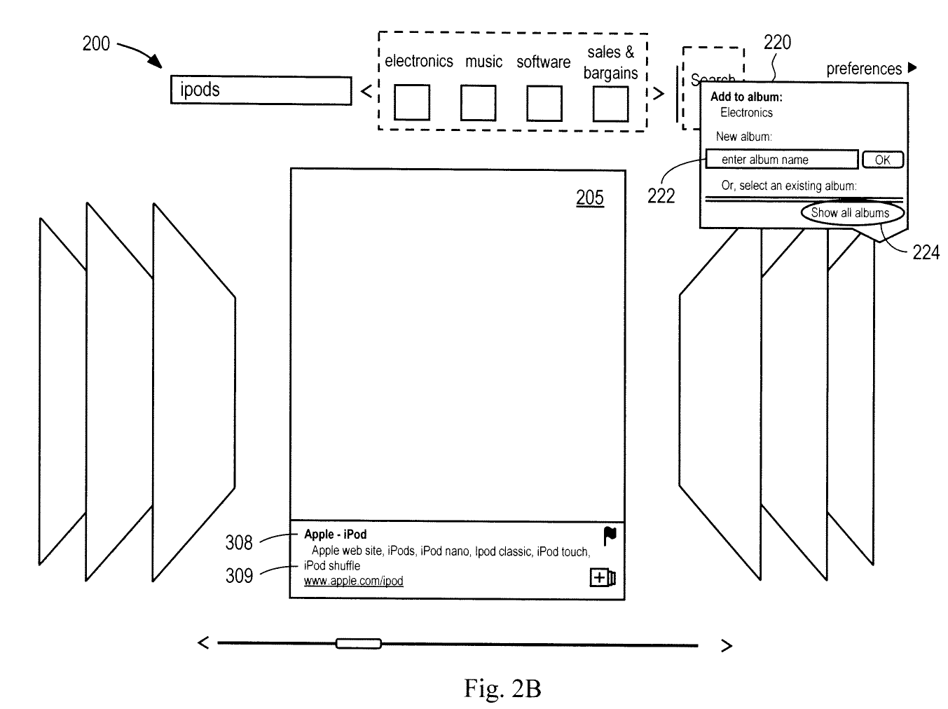

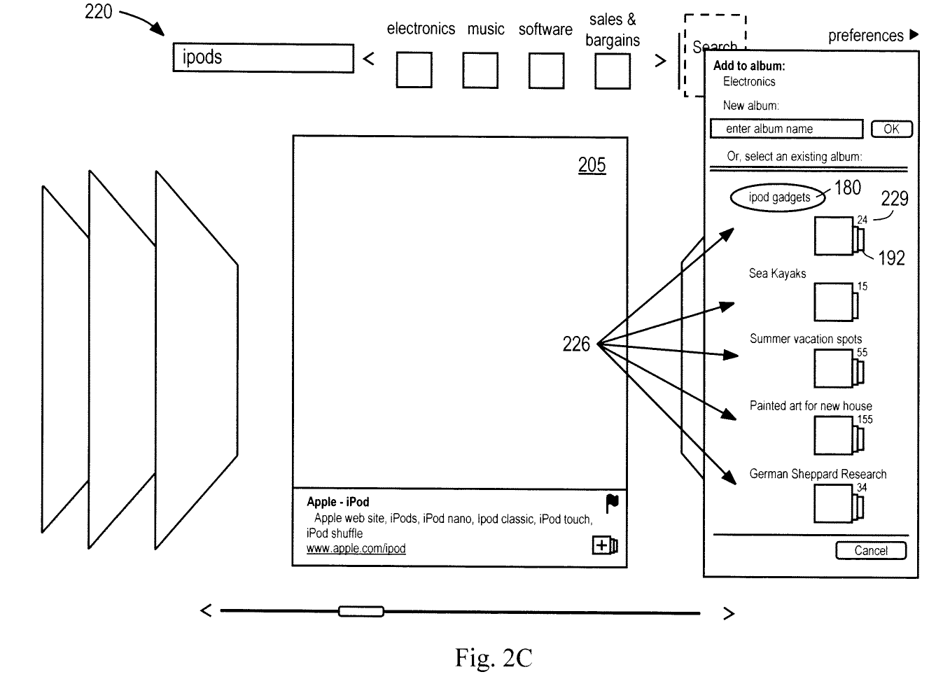

FIG. 2A illustrates an exemplary graphic user interface 200 that is provided by display module 36, typically using web browser 34 of client 100, in accordance with some embodiments. Interface 200 allows a user to create an album 180 of links 196 and/or add links 196 to an existing album 180. In the illustrated embodiment, the interface 200 also allows the user to execute a search of a document index 150 and/or vertical index 138 and to browse web pages or static graphic representations of web pages found in such searches. The user can add selected ones of these web pages or static graphic representations of web pages of interest, found during a search, to one or more albums as links 196.

The interface 200 includes a text entry prompt 201, optional vertical collection buttons 202, an optional “search all” button 203, a plurality of static images of web pages 204, a central static image of a web page 205 which has an associated optional pop-up information bar 206, and optional controls for “preferences” 209 and web page image browsing 207.

The text entry prompt 201 allows the user to enter a query (here, the word “ipods”). The query can be a word, a portion of a word, or multiple words. As the user enters the text query, the interface 200 optionally displays vertical collection buttons 202 that represent the names of candidate vertical collections of static graphic representations indexed by the search engine. In some embodiments “vertical collection” of static graphic representations includes static graphic representations of web pages that relate to a common category. For example, static graphic representations of web pages pertaining to sailboats could constitute a “sailboat” vertical collection 144, and be represented by a sailboat-shaped vertical collection button 202 in interface 200. Static graphic representations of web pages pertaining to car racing could constitute a “car racing” vertical collection 144, and be represented by a car-shaped vertical collection button 202 in interface 200. For further details on exemplary systems and methods for generating candidate vertical collections 144, and for searching indexed web pages based on selected vertical collections 144, see U.S. Patent Publication No. 2007/0244863, filed Apr. 13, 2006 and entitled “Systems and Methods for Performing Searches within Vertical Domains,” the entire contents of which are hereby incorporated by reference herein.

As the user enters the query into text entry prompt 201 (e.g., enters a portion of a word), the search engine returns vertical collection buttons 202 that match the query. As described in U.S. 2007/0244863, in some embodiments, as additional characters of the query are entered, the search engine can change which vertical collection buttons 202 are displayed, as the user's query changes (e.g., as the user enters additional characters into the text entry prompt). The user can select one of the vertical collection buttons 202 and proceed to search the corresponding vertical collection based on the query. Alternatively, the user can select the “search all” button 203 to search a document index that represents the entire Internet, or an intranet, using the query. In some embodiments, there are no vertical collection buttons 202 displayed, and the user can simply press a predetermined key, such as carriage return, or some logical equivalent, and thus search static graphic representations of documents in a document index 150 that represents the entire Internet, intranet, or some other distributed set of documents. As used herein, a document index 150 represents the entire Internet when documents were pulled from more than 100 locations, or more than 1000 locations, or more than 1 million locations, or more than 1 billion locations on the Internet, an intranet, or some set of documents distributed amongst a plurality of computers, e.g., more than 10, or more than 100 computers.

FIG. 2A illustrates the results of a search based on the user query “ipods” using the “electronics” vertical collection button 202. The interface 200 displays a plurality of web pages and/or static graphic representations within the “electronics” vertical collection 144 that match the user query. A web page or central static graphic representation of a web page 205 from the search results is displayed at a central position in the interface 200, while the search result hits 204 are displayed in perspective view, analogously to pieces of paper in an album, at off-center positions and optionally at reduced size. The user can shift other search result hits 204 through the center of the interface using slider 207, arrow keys, or any other suitable user input, and thus readily inspect the search query hits. In some embodiments, in the case where the displayed search result 205 is a static graphic representation of the web page, the interface optionally provides the ability to replace the static graphic representation 205 of a web page with a live version of the web page. For example, in such embodiments, this web page is loaded directly from the URL or other address from which the static graphic representation was originally built when the user selects the static graphic representation 205 (e.g., by clicking on the static graphic representation 205). Optionally, the interface also accepts user input to flip displayed hit 205 over to show the reverse side of the hit 205 where information associated with the hit is found. Such information may include the URL of the hit, the size of the hit, the file type of the hit, the date the hit was created, and/or the date of last access to the hit, and optionally can contain user input (e.g., a personal comment regarding the hit). For further details, see U.S. patent application Ser. Nos. 11/983,629, 12/045,685, 12/045,691, and 12/045,696, each of which is hereby incorporated by reference herein in its entirety.

The central displayed hit 205 optionally includes annotation box 206. The annotation box 206 includes the title of the hit (e.g., “Apple-iPod”), a selection of words within the document from which the hit 205 was built that relate to the user's query (e.g., “Apple web site, iPods, iPod nano, iPod classic, iPod touch, iPod shuffle”), and a link to the document from which the hit 205 was built. The annotation box 206 also includes an add album button 208, illustrated by a small icon of an album in FIG. 2A, that the user can select in order to add a link to the hit 205 to a selected album. In some embodiments, the annotation box 206 is not initially displayed, or is only partially displayed (e.g., title only), when the user first shifts a hit to the central position 205 of the interface 200. The annotation box 206 then displays in response to the user hovering the mouse pointer over the hit 205, or some other suitable selection gesture.

As illustrated in FIG. 2B, in response to user selection of the add album button 208 for the central hit 205, the interface 200 displays an add album interface 220 that allows the user to select which album 180 to add a link 196 to the selected hit. Using the add album interface 220, the user can select to add a link to the hit having the same name as the vertical collection 144 the user selected when entering the search query (e.g., the “Electronics” vertical collection). Alternatively, the user can begin a new album 180 having a category name provided by the user (e.g., in text box 222). Alternatively, the user can select to add the link 196 to the selected hit to an existing album 180 by clicking the “show all albums” button 224, which brings up a list of buttons representing existing albums 180 from which the user can select. In some embodiments, the list of all existing albums 180 is all the albums 180 for which the user has access privileges 184. In some embodiments, the list of all existing albums 180 is all the albums 180 that have the same classification 182 as a vertical collection 144 that the user searched in order to find the centrally displayed hit 205. In some embodiments, albums 180 are hierarchically arranged within album repository 152 and the “show all albums” 224 button invokes a search module that allows the user to navigate through the hierarchy until the appropriate album 180 is found. In some embodiments, the album interface 220 displays a list of buttons representing existing albums without displaying or requiring the use of the “show all albums” button 224. The different options for allowing a user to provide input regarding an album category are merely illustrative, and not limiting.

FIG. 2C illustrates album interface 220 following user selection of the “show all albums” button 224, indicating that the user wants to add a link to the selected hit 205 to an existing album. In response to user selection of button 224, the album interface 220 displays a list of album buttons 226 that represent different existing albums 180 (e.g., “ipod gadgets,” “Sea Kayaks,” etc.) to which the user can add a link to the selected static graphic representation 205 by clicking a corresponding button 226. In the exemplary interface, each album button 226 includes an album name 180, an album icon 192, and a value representative of how many links 196 to documents are already in the album 229. In the embodiment illustrated in FIG. 2C, the album icon 192 schematically illustrates an album 180 with a number suggestive of the actual number of links 196 in the album 180. For example, in some embodiments, an album 180 with less than 10 links 196 is represented by an icon 192 with a single schematic page, an album 180 with between ten and twenty links 196 is represented by an icon 192 with two schematic pages, an album 180 with more than one hundred links 196 is represented by still another icon 192, and so forth. Other embodiments use other schemes, including schemes that do not use icons to represent a number of links 196 in the album 180). In some embodiments, the album buttons 226 include other information about the albums, such as the last edit date of the album 180, or the name or username of the user who created or last added to the album. Such information is retrieved from the album 180 stored in album repository 154.

Based on the user input, the interface adds the requested link 196 to the appropriate album 180 (here, “ipod gadgets,” based on user selection of the pre-existing album). In other embodiments (not illustrated) the interface 220 automatically adds the link 196 to the selected static graphic representation to an album having the same name as the vertical collection 144 the user selected when entering the query. In still other embodiments (not illustrated) the interface 220 automatically determines the name of an album 180 to which to add the link to the selected hit 205. For example, in some embodiments, the interface 220 adds the link 196 to the hit 205 to an album 180 having a name the user's search query, or may add the link 196 to the hit to an album 180 having a name based on the content of the hit (e.g., terms that occur in the hit).

The user can add links 196 to an album 180 and/or create an album 180 using interfaces other than the interface 220 illustrated in FIGS. 2A-2C. In some embodiments, the user can use web browser 34, in conjunction with display module 36, to add a link 196 to a static graphic representation of a web page or a web page that is currently being displayed by the web browser to an album 180 by dragging and dropping the displayed static graphic representation or web page to a designated area of the graphical user interface (GUI) provided by the combination of the web browser 36 and the display module 36. For example, the GUI may include a plurality of album icons 192 that each represent a different album 180, and the user can add a link 196 to a displayed and selected static graphic representation or web page to one of those albums 180 by dragging and dropping the static graphic representation or web page onto the corresponding album icon 192. In other embodiments, the interface includes a drop-down menu that includes a list of albums 180, and selection of one of the listed albums 180 adds a link to a displayed and selected static graphic representation or web site to that album 180. In another embodiment, the interface includes a button that can be clicked to indicate that the user wants to add a link 196 to the centrally located static graphic representation or web site 205 of FIG. 2C to an album 180, but without requiring the user to provide additional information at that time about the particular album 180 to which the link should be added. The interface can add the link 196 to the static graphic representation or web site to a “to be categorized” temporary holding album 180 that the user can later review and categorize. The links 196 in such an album 180 can be sorted by the date that the user added such links 196 to the album and/or, in embodiments that make use of vertical collections 144, by the vertical collections 144 to which the links 196 belong. Alternately, the interface can automatically add the link 196 to the selected static graphic representation or web site to an album 180 having a classification 182 corresponding to a vertical collection 144 to which the static graphic representation rendering or web site belongs. Other suitable interfaces can also be used. In some embodiments, the user can create album types such as “my personal images” or “research project for class.”

In some embodiments, display module 36 is a toolbar is added to a conventional web browser 34, such as Internet Explorer, that provides some or all of the above-described functionality without any requirement for a specialized interface. The toolbar contains an input feature, such as a button, allowing a user to add a static graphic representation, web site, or any other document that is index by a URL or equivalent address, which is currently displayed, to an album. Activation of the interface sends a link 196 of the static graphic representation, web site, or equivalent document to the album 180 selected for the user. The album itself, comprising links 196, may be on a remote server, such as the server 178 illustrated in FIG. 1B, or on the computer 100 associated with the user. Optionally, the interface also allows the user to enter information identifying the album 180 to which the link 196 is to be added. In some embodiments, cookies, logins, or other identifiers are identify the user without human intervention so that the link 196 can be added to an album 180 associated with a user. Alternatively, the link 196 is sent to a remote server where albums are stored (e.g., album repository 156 of server 178 illustrated in FIG. 1B). Upon receiving the link 196, the remote server queries the user, e.g. using a web page form provided by display module 36, for information on which album 180 should be appended to include the link 196. Such information provided, in some embodiments, in response to the query for a valid album 180 is, for example, user identity information and/or any other information that can be used to uniquely identify an album 180 stored by the server 178.

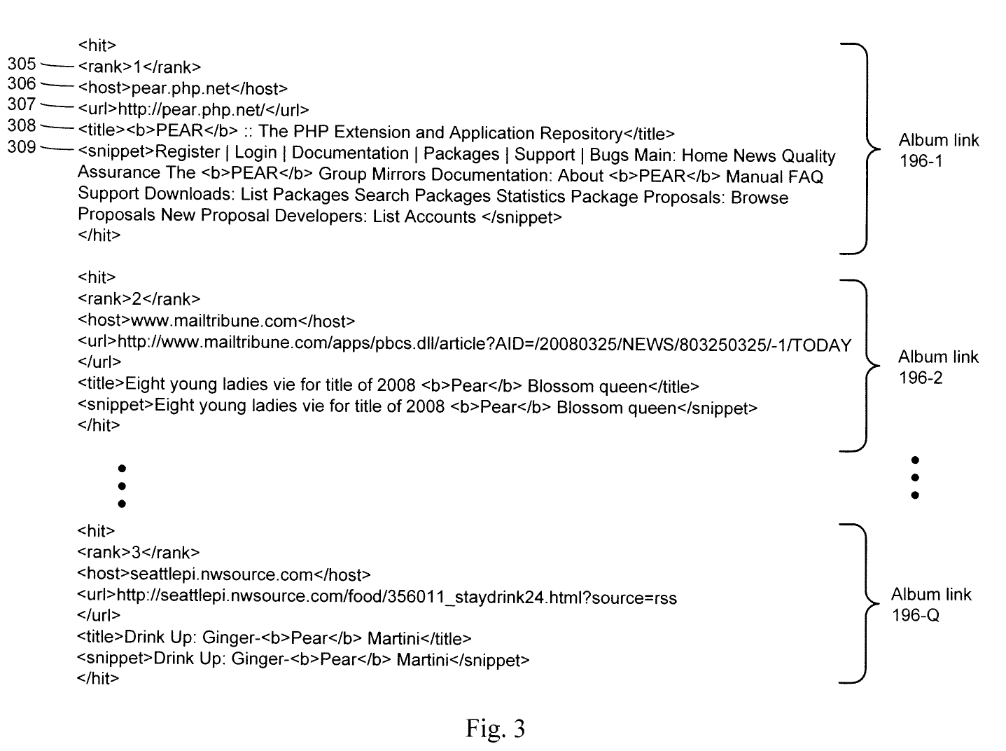

In some embodiments, an album 180 is stored as computer readable code (e.g., an extensible markup language document) that contains links 196 to the static graphic representations, web sites, or other documents linked to the album 180 and optionally instructions for displaying such documents. When the computer readable code is selected, e.g., by clicking an icon 192 that links to a document containing the computer readable code of the album uniquely associated with the icon 192, the album pages, where each page of the album is the document associated with a link 196 within the album 180, is displayed to the user. In some embodiments, computer readable code that contains a subset of the information in an album is generated. For example, in some embodiments, only core information in an album 180 stored in album repository 154 is placed in a computer readable file that is external to the stored album. Such core information can be, for example, the name of the album, the links 196 in the album, and the album identifier. This computer readable file is then shared with other users. When other uses access the computer readable file, a record of such access is optionally recorded in the usage history record 186. In some embodiments, the entire album, including any combination of the elements of an album 180 described above in conjunction with FIG. 1D is stored in on computer readable medium in the form of computer code that can be parsed and read by web browser 34 (e.g., operating under the instructions of display module 36). The text of an exemplary computer readable file in accordance with such embodiments is illustrated in FIG. 3 in which only the links 196 are placed in the file. The document includes entries for links 196.

Advantageously, in the embodiment illustrated in FIG. 3, the code used to store the links 196 within the album 180 is formatted in the same manner in which hit results to a user query are formatted by search engine 136. Therefore, the same application that displays the results of a user query can seamlessly be used to display the pages of an album 180. In some embodiments, as in the case of hit results responsive to a user query, each respective link 196 in the album includes a rank 305 that ranks the respective link 196. Whereas, in the case of search results, rank 305 has meaning (e.g., the first ranked link to a static graphic representation is typically the top ranked search result and/or a paid advertisement), in the case of albums, rank 305 serves to order the links to static graphic representations (e.g., the first link is for the first page of the album and so forth) and this order can be edited by a user when reviewing or creating the album defined by the code illustrated in FIG. 3. In some embodiments rank 305 is not used in albums 180 but is optionally present in the computer readable media in order to be seamlessly compatible with search results from search engine 136. In the embodiment illustrated in FIG. 3, the entries for each respective link 196 further include an identifier for the source host (domain) 306 from which the document associated with the respective link was obtained, the actual uniform resource location (URL) 307 for the document (e.g., URL to a static graphic representation of a web page in document repository 152, URL to a web page on the Internet, etc.), a title 308 for the link, and an annotation 309 for the link.

While, in the embodiment illustrated in FIG. 3, the URL 307 is the full URL to the location of the source web page on the Internet for the corresponding static graphic representation 301, there is no absolute requirement that the URL be accessed when the album is displayed in some embodiments. Rather, in some embodiments, the URL 307 is used to obtain a rendered static graphic representation of the web page from a central server. For example, in some embodiments, the URL 307 is hashed to obtain a unique index value for the corresponding static graphic representation in document repository 154 of server 178. In some embodiments, document repository 152 contains not only the database of static graphic representations for the album 180, but all the static graphic representations of web pages obtained in successive crawls of all or a portion of the web pages on the Internet. In some embodiments where URLs 307 are used to obtain the static graphic representations from a database, such as document repository 152, the administrator of the database maintains control over the static graphic representations that are used to form albums 180.

In the embodiment illustrated in FIG. 3, the title 308 of the link 196 is typically the title of the web page or other document to which the link 196 points. For example, if document is a web page and includes a <TITLE>/</TITLE> element, the code or text bounded by the <TITLE>/</TITLE> element in the web page can serve as the title 308 of the line 196. In some alternative embodiments, title 308 is selected or edited by the user that added the link 196 to the album 180. The annotation 309 for the link 196 is, in some embodiments, a selection of words within the document pointed to by the link that relate to a query that was used by the user to find the document using a search engine. As illustrated in FIG. 2B the title 308 and annotations 309 are displayed at the bottom of centrally displayed page 205 of the album 180 in some embodiments. In some embodiments, any or all of the elements 305, 306, 307, 308, and 309 are stored in an album 180 along with any of the elements described above in conjunction with FIG. 1D.

Of course, there is no requirement that albums 180 be stored in the format illustrated in FIG. 3. As indicated above, the XML code in FIG. 3 is merely one exemplary embodiment in which the album 180 is stored in code that parsable by the same software module that parses user query search results from search engine 136. At a minimum, an album 180 contains a plurality of links, where each link 196 in the plurality of links is an address of a static graphic representation of a web page, a web page, or some other document with an Internet or network address. The album 180 can be stored in ASCII format, binary format, an encrypted format, XML code, PERL code, HTML code or any other computer-readable format that allows for the storage of links 196. In preferred embodiments, the album 180 does not contain the linked documents themselves, just links 196 to the documents.

Regardless of the form used to store the album 180, the album itself can be stored locally, e.g., on the user's computer, or remotely, e.g., on the server 176 running the search engine 136. In typically embodiments each respective link 196 in an album 180 contains the full address or other form of identifier that is sufficient to retrieve the document identified by the respective link 196 from a remote computer. As defined herein, a “remote computer” is any computer other than the computer 100 used by a user to browse a network. The remote computer can be right next to the computer 100 and electronically connected to the computer 100, but is more typically located in another building and is accessible to computer 100 by the Internet or some other wide area network. A user can have any number of albums 180, e.g., one or more albums 180, more than ten albums 180, or more than 100 albums 180, each of which can, independently be stored locally or remotely.

### 3. Displaying, Editing, and Sharing Albums

Users can view, edit, and share visually grouped albums 180. A user can browse through pages in an album via an interface that presents the user with the album without requiring the user to click on the links 196 contained within the album that are the source of the album pages.

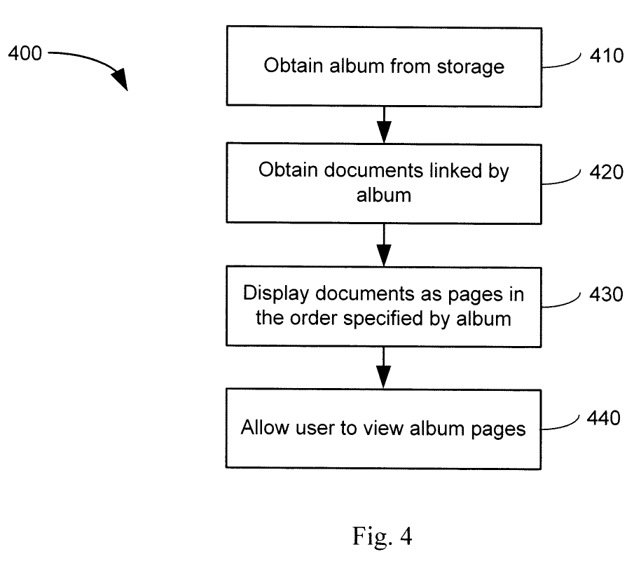

FIG. 4 illustrates an exemplary method 400 of displaying an album 180 according to some embodiments. The album 180 is obtained from storage (410). In one example, the album is stored as an XML document (e.g., in the format illustrated in FIG. 3), and is obtained in step 410 from storage for processing. In some embodiments step 410 occurs when a user clicks on an icon 192 that represents the album 180. Once the album has been obtained, the documents linked by the album are obtained (420). For instance, in the case where the album is an XML document that lists the source URLs for web sites used to generate static graphic representations in the album, those URLs can be used as identifiers for retrieving static graphic representations that correspond to those web pages stored in a data structure, such as document repository 152, controlled by a data structure administrator. In the exemplary method illustrated in FIG. 4, the retrieved documents (e.g., static graphic representations of web pages, web pages, other documents that have a network address) are displayed in an order defined by the album (430). In one embodiment, a page corresponding to a rank of “1” in the album is displayed in a central position of the interface, and pages with other ranks are displayed in non-central locations, as described in greater detail below. The pages can be browsed, e.g., by shifting the pages through the central position of the interface, in response to user input (440), thus allowing the user to view the content of the album. Here, each “page” corresponds to a link 196 to a document such as a static graphic representation of a web page.

Optionally, in some embodiments, in response to user input (e.g., selection of a page), the page is replaced with a live version of the page from the source web page used to build the page. In some circumstances, the live version of the web page may have been updated after the page was rendered and stored in the document repository 152. In such instances, replacement of the page with the corresponding live version of the source web page used to build the page in response to user input will potentially result in different content being displayed. In some embodiments, the interface can provide the user with information about the date that the page was rendered and/or the date that the live version of the page was most recently updated. In some embodiments, the feature of providing a live web version of the static graphic representation is not offered. In some embodiments, one or more pages of the album are live versions of web pages that are retrieved from the Internet during step 430.

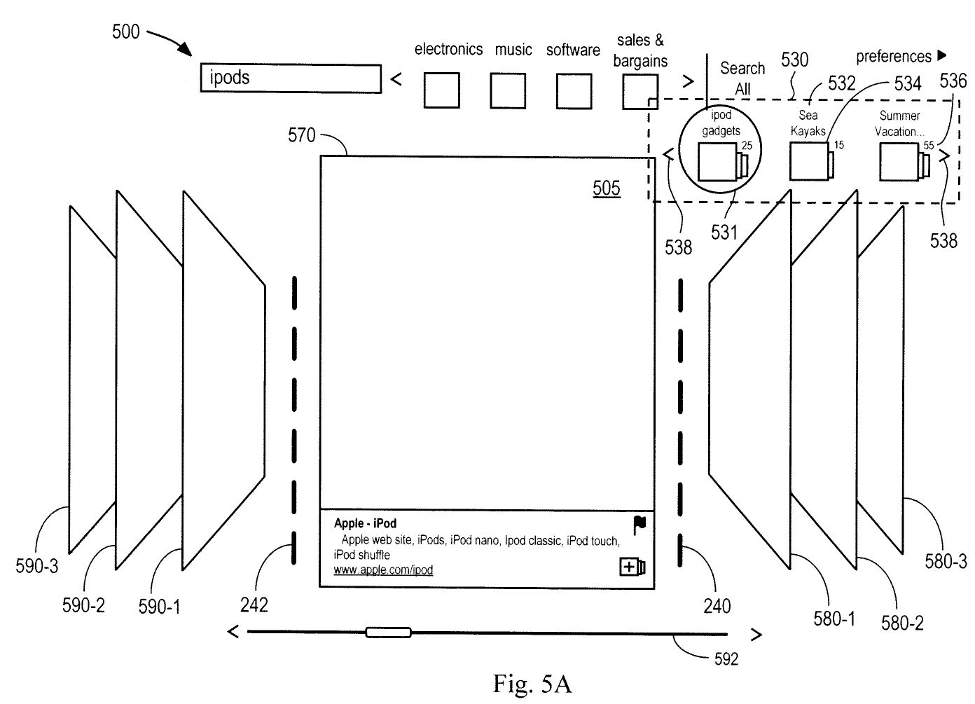

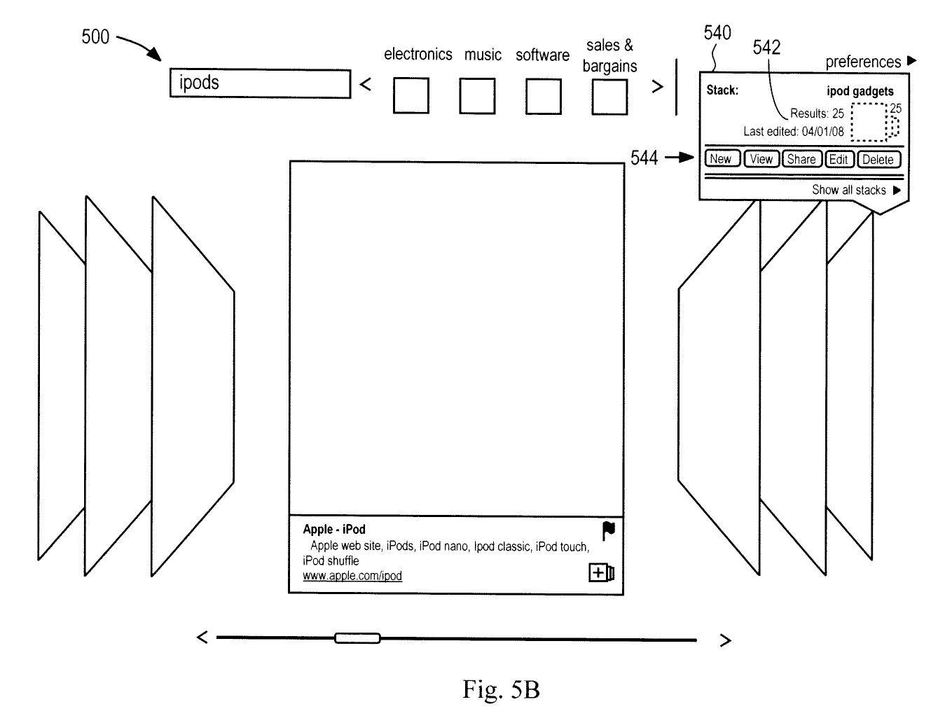

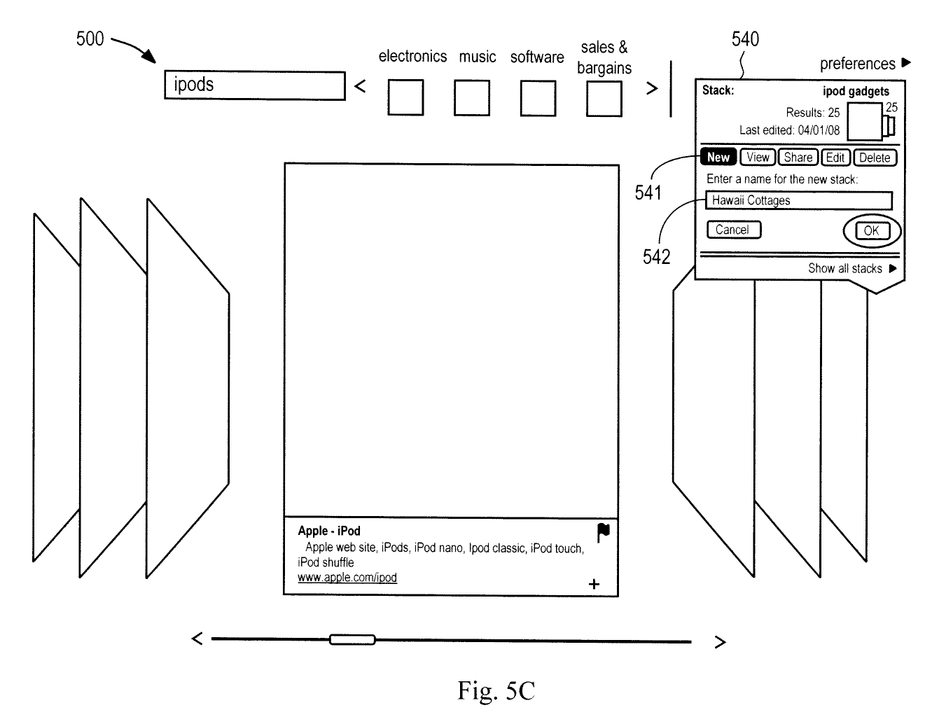

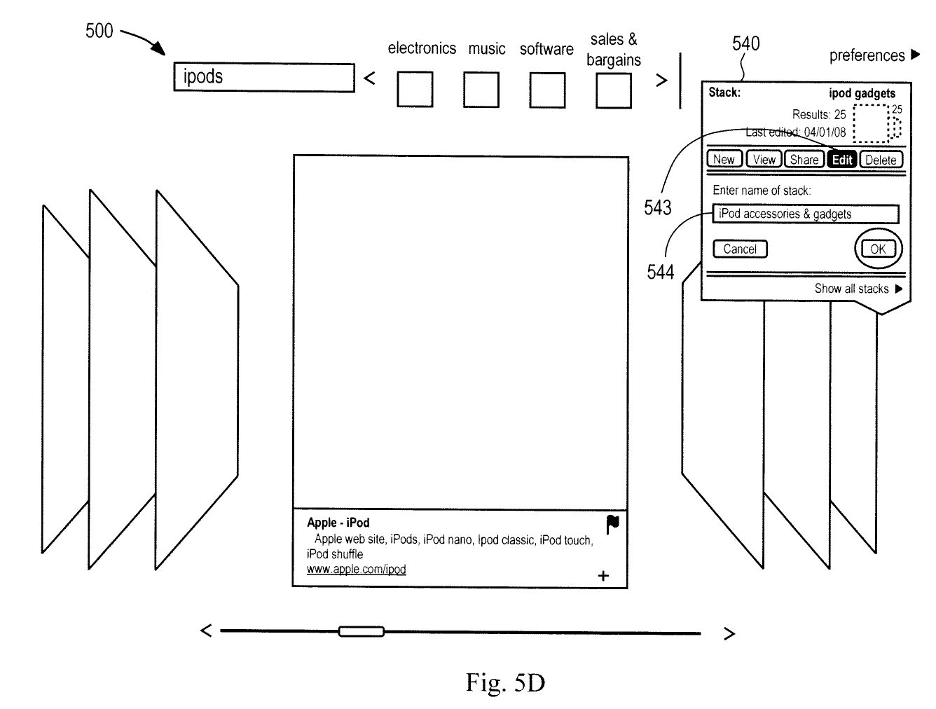

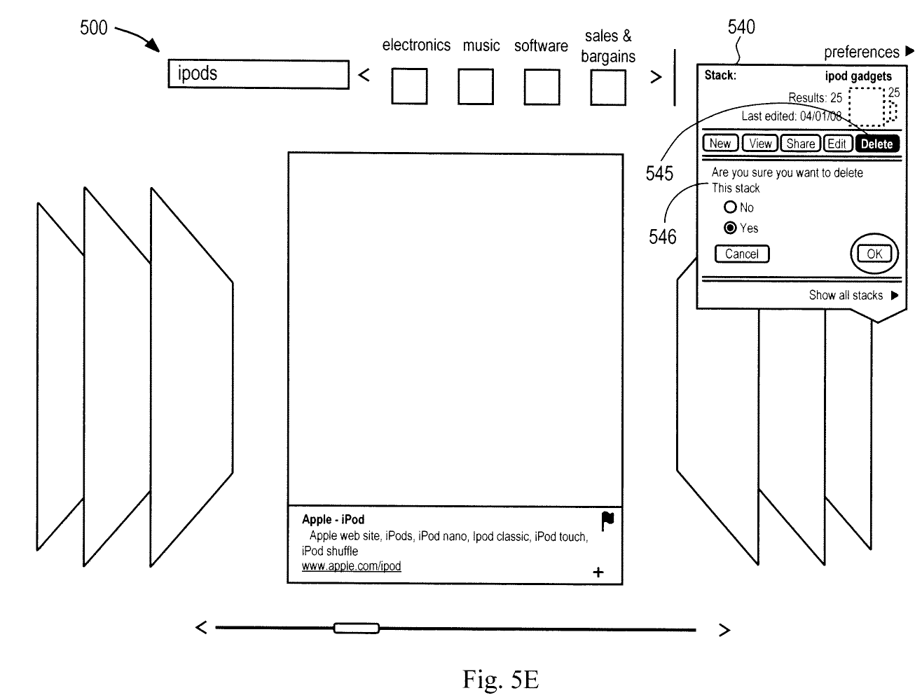

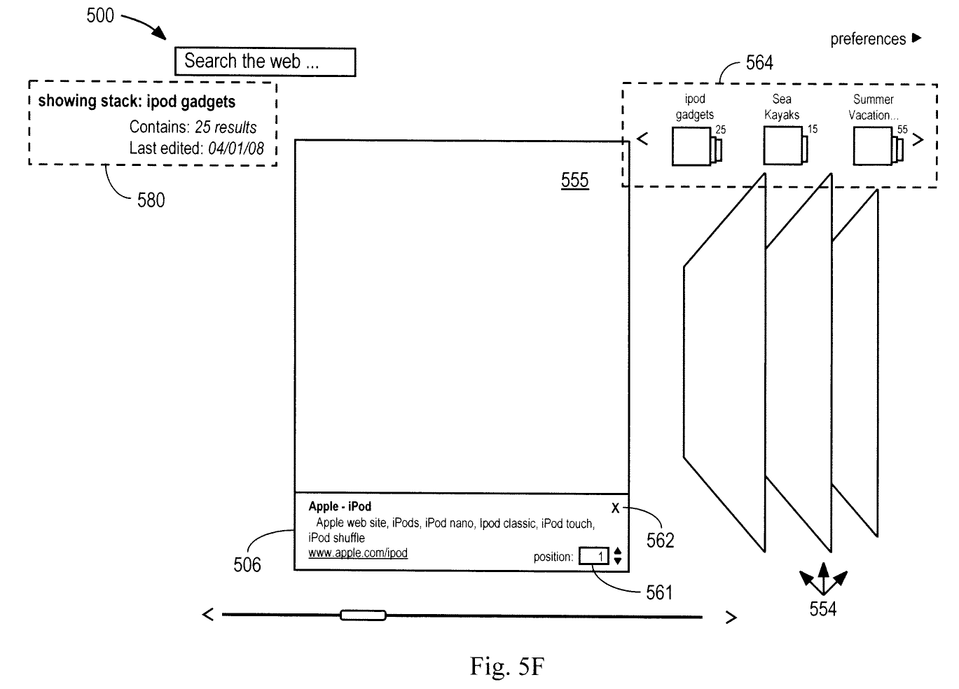

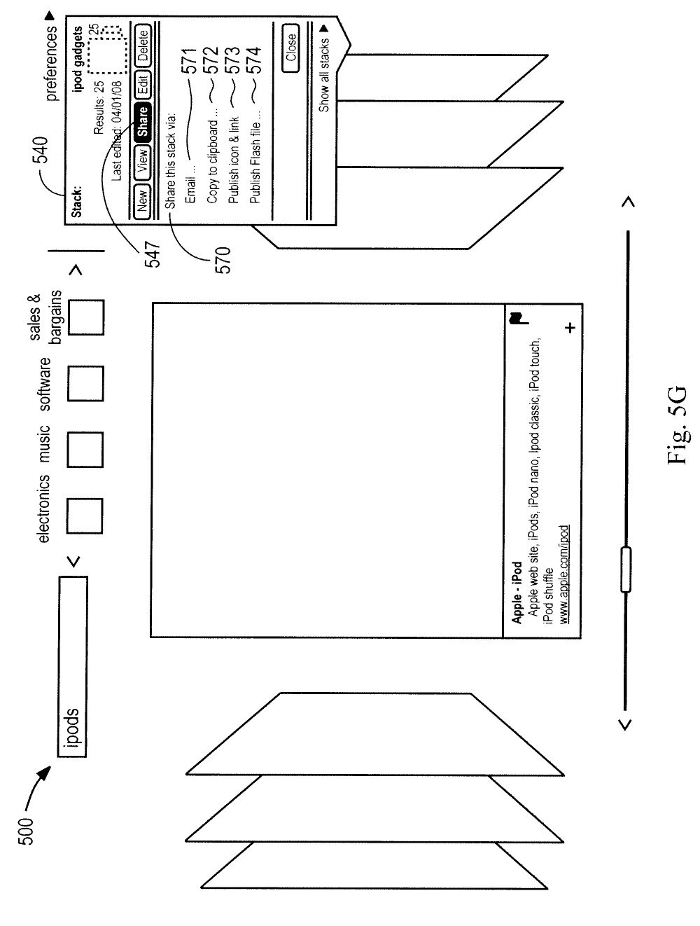

FIG. 5A illustrates an interface 500 that allows a user to view, edit, or share an albums 180. Like the interface 200 of FIGS. 2A-2C, interface 500 allows the user to seamlessly execute a document search and to browse hits found during such searches. In the illustrated embodiment, interface 500 displays hits 505 obtained as the result of a query based on the word “ipod” and the vertical collection 144 constraint “electronics.”

Interface 500 includes an album browsing interface 530 that allows a user to select an album 180 to view, edit, or share. The interface includes a plurality of album buttons 531 that represent different albums. Each album button includes the name of the album 532, an icon representing the album 534, which optionally schematically illustrates the size of the album, and a value 536 representative of how many links 196 are in the album. When the user has more albums than can be presented at a single time within album browsing interface 530, arrows 538 are displayed that allows the user to scroll through the icons of the albums 180. In some embodiments, each album icon 192 is a link to a data structure (e.g., a file containing XML) that contains the album 180.

FIG. 5B illustrates interface 500 following user selection of the album button 531 (here, “ipod gadgets”). Responsive to this user selection, the exemplary interface 500 is refreshed to include an album editing interface 540 that displays information about the selected album 542 (e.g., the number of links 196 in the album, the last album edit date, etc.), and that also allows a user to edit, view, share, or delete the selected album 180, or to create a new album 180 using album editing buttons 544. Selection of an album editing button 544 causes interface 500 to take appropriate action. The functionality of the different buttons 544 is described below.

As illustrated in FIG. 5C, selection of the 37 New” button 541 opens a text prompt interface 342 that allows the user to enter the name of a new album (here, “Hawaii Cottages”). In response to user input, the interface creates a new album of that name, but which has no links 196. The user can then add links 196 to that album 180, e.g., as described above. In some embodiments, selection of the “New” button 541 creates a new data structure (e.g., a file such as shown in FIG. 3) using user input to fill in category 304.

As illustrated in FIG. 5D, selection of the “Edit” button 543 opens a text prompt interface 544 that allows the user to enter a new name for the existing album (here, “iPod accessories & gadgets”). In response to user input, the interface changes the name of the album. In some embodiments, selection of the “Edit” button 543 modifies a document containing an album, such as the shown in FIG. 3, by replacing the existing category 304 with a new one defined by user input.

As illustrated in FIG. 5E, selection of the “Delete” button 545 opens a confirmation prompt 546 confirming that the user actually wants to delete the album 180. In response to user input, the interface deletes the album. In some embodiments, selection of the “Delete” button 545 deletes a document storing the album 180.

FIG. 5F illustrates interface 500 in a mode that allows the user to view the contents of an album in response to selection of the “View” button illustrated in the album editing interface 540 of FIG. 5B. As illustrated in FIG. 5F, interface 500 includes an album information area 580 that displays information about the currently selected album, including how many links 196 are in the album and the last edit date of the album 180. In some embodiments, the album information area 580 also displays other types of information, such as the last edit date of the album, or the name or username of the user who created or last added to the album 180. The interface 500 also includes album browsing interface 530 that allows a user to select a different album, or to edit or share the currently selected album.

The interface 500 displays the pages of the selected album similarly to the way that interface 200 described above displays search hits. The interface 500 displays a plurality of pages, where each page is the document (e.g., web page, static graphic representation of a web page, etc.) referenced by the links 196 of the selected album (here, “ipod gadgets”). A central page 555 is displayed at a center position in the interface 500, while the other pages 554 are displayed in perspective view, analogously to pieces of paper in an album, at off-center positions and optionally at reduced size. The user can browse through the pages, as above. In some embodiments, when the user selects the central page 555 (e.g., by clicking on the page 555), the interface replaces the page 555 with a “live” version of a web page retrieved from the URL corresponding to the page. The visual grouping of pages into the album thus allows the user to readily view, apprehend, and browse the content of the pages in the album.

The interface 500 also allows a user to modify the contents of the displayed album. For example, in the illustrated embodiment, the annotation box 506 includes position control 561 that allows the user to change the position of the pages 555 (“Apple-iPod”) to other positions in the album, and thus the order of the links 196 that correspond to the pages. For example, the document addressed by a link 196 that is at position “1” in an album 180, is first document as a page when the user selects this album to view. The user can use the position control 561, e.g., the up and down arrows or the text entry box, to modify the order in which that page is displayed relative to the other pages 554 in the album. In some embodiments, use of the position control 561 modifies the rank 305 of the corresponding link 196 within an XML document, as illustrated in FIG. 3. The annotation box 506 in FIG. 5 also includes deletion control 562 that allows the user to delete the static graphic representation 555 from the album.

In some embodiments (not illustrated) the interface 500 allows the user to search for pages within the displayed album. For example, the interface can accept a query at the text entry prompt and display a “search this album” button that allows the user to search only within that album. In such embodiments, referring to FIG. 2B, a search through the titles 308 and/or annotations 309 of the pages is done to find matching pages.

As illustrated in FIG. 5G, selection of the share button 547 opens a sharing interface 570 that allows the user to share the selected album with others. The album can be shared in several different formats, each of which will be discussed in turn. These formats are merely illustrative. Other formats can also (or alternatively) be used. Selection of “Email . . . ” 571 creates an email in the user's default email program that includes either a link to album or the entire album itself. In one example, the album is represented in the Email as an icon that includes a thumbnail (reduced size image) of the first static graphic representation in the album and the category of the album (e.g., one example of an icon 192). The representation of the album also includes code instructing an appropriate interface to be launched (e.g., a suitable web browser 34 and/or display module 36), and either the album itself (e.g., an XML document as illustrated in FIG. 3) or an identifier for the album (e.g., a link to an XML document on a remote server). When the email recipient selects the representation of the album 180 (e.g., by double clicking on the icon 192 in the received email), the interface launches and the pages in the album are displayed, e.g., as illustrated in FIG. 5F. Thus, the email recipient can visually review the grouped pages of the album, where each page is a document addressed by a corresponding link 192 in the album 180.

Selection of “Copy to clipboard . . . ” 572 copies the contents of an album to the clipboard. When an album is copied to the clipboard, the links 192 in the album, at a minimum, are copied to the clipboard. For example, consider the case where the album has the format illustrated in FIG. 3 and/or FIG. 1D. By selection of button 572, the entire file illustrated in FIG. 3 and/or some or all of the components illustrated in FIG. 1D are copied to a clipboard. This is useful in instances where it is desired to post the album in a blog entry, in a website, or other means for electronic communication of information.

Selection of “Publish icon & link” 573 generates a representation of the album 180 that is the same as that described above for “Email . . . , ” but instead of inserting the representation of the album into an email, the interface publishes the representation of the album on a web page. In one example, after selecting “Publish icon & link,” the user inputs a web page, such as the user's blog, onto which the representation of the album is to be published. The representation of the album (e.g., icon 192) is then inserted into the web page, optionally at a location defined by further user input.

Selection of “Publish Flash file . . . ” 574 generates a graphic file that contains the documents linked by the album 180 along with their associated links, and that accepts user input to browse among the images and/or to launch a live version of a web page by selecting the corresponding static graphic representation. The user can post the file to a web page, email the file to other users, or share the file by any other suitable format. In some embodiments, the file generates an interface that looks similar to that shown in FIG. 5F, but that lacks search engine and/or album editing functionality.

Optionally, shared albums can be modified by other users and stored under the same category or under a new category. For example, the user can designate an album as “public” (e.g., viewable and/or modifiable by others), or as “private” (e.g., only viewable and modifiable by the user).

### 4. Using Album Content to Provide Users with Additional Information

In general, each page of an album has some type of content, and users tend to group such pages based on related content. Thus, an album 180 can be thought of as an accumulation of content that is likely related (noting, of course, that in most embodiments there are no constraints on the contents of documents that are linked to any given album). In some embodiments, the content of an album is used to provide the user with additional information that may be of interest, based on the content. Such additional information can be in the form, for example, of an additional web page, or an advertisement for a product or service, that may be of interest to the user because it relates to the content of the album.

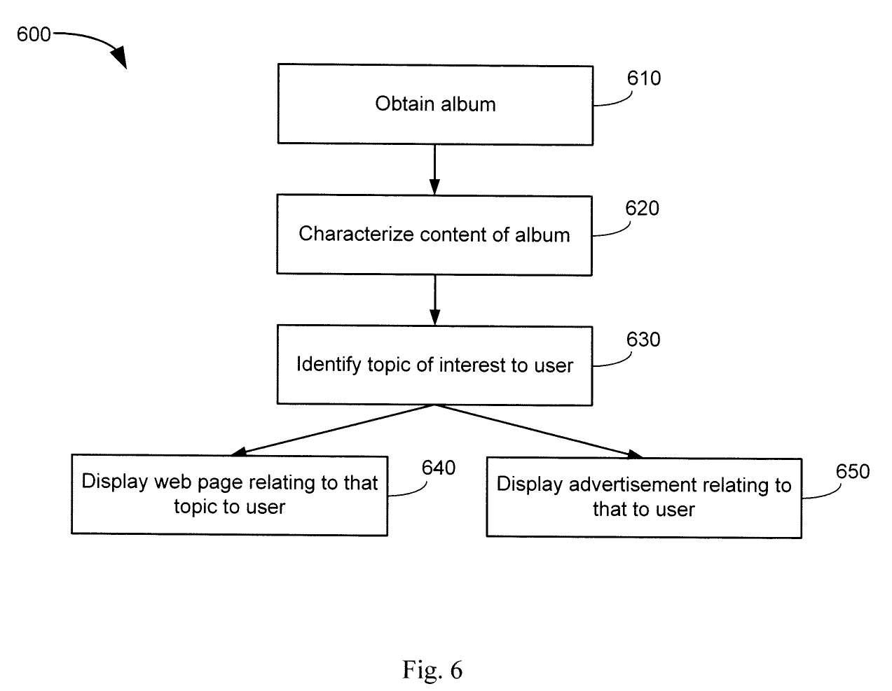

FIG. 6 illustrates a method 600 of a providing a user with additional information based on the content of an album, according to some embodiments. First, an album is obtained (610), for example, from local or remote storage. Then, the content of the album is characterized (620), for example, using one of the methods described below. Then, a topic of interest to the user is identified based on the characterization of the content of the album (630). A web page relating to that topic is then displayed to the user (640) and/or an advertisement relating to that topic is displayed to the user (650). Some exemplary options for displaying such additional information to the user is described below.

The content of an album can be characterized, and topics of interest to the user identified, in many different ways. For example, as noted above, web pages can be associated with “vertical collections” that contain related content. By extension, an album can be associated with one or more vertical collections, depending on the associations of the web pages or static graphic representations of web pages linked by album. In one example, a user may create an album of category “ipod gadgets,” and may add links to the album, some or all of which relate to iPods and are in an “electronics” vertical collection. Information about the vertical collections, if any, with which the links in the album are associated, can be stored in the album. Using the XML example in FIG. 3, each entry for a static graphic representation 301 can include a list of vertical collections to which the links belong. Regardless of the particular implementation, the information about the vertical collections to which the links in an album belong can be analyzed to identify, for example, which vertical collections the links have the most in common (e.g., the most frequently occurring vertical collection associated with the web pages linked by the album). The identified vertical collections can be assumed to represent topics of interest to the user, and additional information relating to such topics of interest can be provided to the user. For further details on vertical collections 144, see U.S. Patent Publication No. 2007/0244863, filed Apr. 13, 2006 and entitled “Systems and Methods for Performing Searches within Vertical Domains,” which is hereby incorporated by reference herein in its entirety.

In one simple example, the content of an album is characterized based on the classification (category) 182 of the album and/or the characterization 198 of any of the links 196 of the album 180. As noted above, the classification 182 of the album can be assigned by the user, or can be automatically assigned, e.g., based on the vertical collection 144 to which the links 196 in the album 180 belong. The album classification 182 can be assumed to represent a topic of interest to the user, and additional information relating to that topic of interest can be provided to the user.

The content of an album can also be characterized by analyzing the frequency of words that occur within documents linked to the album 180. Words that occur the most frequently in such linked documents and that are meaningful (e.g., not articles such as “the” or “and”) can be assumed to relate to topics of interest to the user. Additional information relating to that topic of interest can be provided to the user.

The popularity of links 196 within an album 180 can also be used to identify topics of potential interest to the user. If a link 180 in an album is particularly popular, e.g., that many other web pages link to the web page from which the album page was created, that page in the album can be assumed to relate to content of interest to the user. Additional information relating to that topic of interest can be provided to the user.

In some embodiments, the content of more than one album is characterized in order to identify topics that are of interest to the user. For example, links 196 can be added to more than one album. A given album can include information about the identity of the other albums that contain pages identical to or similar to the pages in the given album. Based on the information about the different types of albums of interest to the user, and about the frequencies of links 196 within those albums, topics of potential interest to the user can be identified based on the albums of the most apparent interest to the user. Additional information relating to those topics of interest can be provided to the user.

There are many suitable ways to display additional information, such as other static graphic representations, web pages and/or advertisements of potential interest, to the user. In some embodiments, images of other web pages, static graphic representations, and/or advertisements can be interleaved among the images in the album that the user is viewing. As the user browses through the album pages, another web page, static graphic representation, and/or advertisement is occasionally shifted into the central region of the interface. In some embodiments, an advertisement can be displayed as a background against which the album can be viewed. For example, if the user is viewing an album of category “travel” or if traveling is otherwise identified as being a topic of interest to the user, a graphic for a travel agency and/or words advertising the travel agency can be displayed in the background. In other embodiments, “branded” album buttons can be displayed to the user, e.g., interspersed among the album buttons 226 illustrated in FIG. 2C. The branded album buttons can relate to topics of apparent interest to the user based on the content of the web page, static graphic representations, or the content of one or more existing user albums.

The additional static graphic representations, web pages and/or advertisements can be prepared in advance (e.g., images of them obtained), stored locally or remotely, and pre-associated with particular topics. Then, if a topic is identified as being of interest to the user, an appropriate web page and/or advertisement can be obtained and displayed to the user. Text-based advertisements can also be displayed to the user. For example, text-based ads can be stored locally or remotely, and pre-associated with particular topics. For example, in some embodiments such advertisements are provided by advertisement repository 156. Then, if a topic is identified as being of interest to the user, an appropriate text-based advertisement can be displayed to the user, e.g., adjacent the album information area 580 illustrated FIG. 5F.

Data feeds or “widgets” can also be displayed to the user. For example, widgets can be stored locally or remotely, and pre-associated with particular topics. Then, if a topic is identified as being of interest to the user, the widget can be loaded into the interface (e.g., interface 500 of FIG. 5F) and can communicate directly with the advertiser.

Additional information, such as the additional web pages, static graphic representations, and/or advertisements described above, can also be displayed to the user while the user is viewing the results of a web search. For example, topics of interest to the user can be identified based on the web searches the user executes.

### 5. Search Engine Embodiments

Referring to FIG. 1B, and as discussed above, in some embodiments server 178 provides search engine functionality. In some embodiments, such search engine functionality can be a conventional search engine functionality in which a generalized document index is built from documents retrieved from one or more web crawls. In other embodiments, such search engine functionality is an enhanced search engine functionality in which each of the documents obtained from one or more web crawls is categorized based on the content of such documents into one or more vertical collections. For instance, specialized classifiers, which have been trained on documents of known categories, can be used to automatically classify, without user intervention, documents from the one or more web crawls into vertical collections.

Regardless of search engine type, a document index 150 is constructed in order to provide the optional search engine capability. In some embodiments, a document index 150 is constructed by scanning documents on the Internet and/or intranet for relevant search terms. An exemplary document index 150 is illustrated below:

| Term | Document Identifier |
|---|---|
| term 1 | DocID₁ₐ, . . . , docID₁ₓ |
| term 2 | DocID₂ₐ, . . . , docID₂ₓ |
| term 3 | DocID₃ₐ, . . . , docID₃ₓ |
| . | |
| . | |
| . | |
| term N | docID_{Na}, . . . , docID_{Nx} |

In some embodiments, the document index 150 is constructed by conventional indexing techniques. Exemplary indexing techniques are disclosed in, for example, U.S. Patent Publication No. 2006/0031195, which is hereby incorporated by reference herein in its entirety.

By way of illustration, in some embodiments, a given term may be associated with a particular document when the term appears more than a threshold number of times in the document. In some embodiments, a given term may be associated with a particular document when the term achieves more than a threshold score. Criteria that can be used to score a document relative to a candidate term include, but are not limited to, (i) a number of times the candidate term appears in an upper portion of the document, (ii) a normalized average position of the candidate term within the document, (iii) a number of characters in the candidate term, and/or (iv) a number of times the document is referenced by other documents. High scoring documents are associated with the term. In some embodiments, document index 150 stores the list of terms, a document identifier uniquely identifying each document associated with terms in the list of terms and, optionally, the scores of these documents. In some embodiments, the document identifier uniquely identifying each document is a uniform resource location (URL) or a value or number that represents a uniform resource location (URL). Those of skill in the art will appreciate that there are numerous methods for associating terms with documents in order to build document index 150 and all such methods can be used to construct document index 150 of the present invention.

There is no limit to the number of terms that may be present in document index 150. Moreover, there is no limit on the number of documents that can be associated with each term in document index 150. For example, in some embodiments, between zero and 100 documents are associated with a search term, between zero and 1000 documents are associated with a search term, between zero and 10,000 documents are associated with a search term, or more than 10,000 documents are associated with a search term within document index 150. Moreover, there is no limit on the number of search terms to which a given document can be associated. For example, in some embodiments, a given document is associated with between zero and 10 search terms, or between zero and 100 search terms, or between zero and 1000 search terms, or between zero and 10,000 search terms, or more than 10,000 search terms.

In the context of this application, documents are understood to be any type of media that can be indexed and retrieved by a search engine, provided that such documents code for a unique web page that is available on the Internet. Thus, there is a one-to-one correspondence between a document and a unique web page available on the Internet. A document may code for one or more web pages as appropriate to its content and type. There are many documents indexed. Typically, there are more than one hundred thousand documents, or more than one million documents, or more than one billion documents, or even more than one trillion documents present in document index 150.

In some embodiments, for each document referenced by document index 150, search engine server 178 stores or can electronically retrieve (i) the source document or a document identifier 146 (document reference) that can be used to retrieve the source document, (ii) a static graphic representation 148 of the source document, and (iii) optionally key words contained within the document or a title of the document. In some embodiments, for each document referenced by document index 150, search engine server 178 stores or can electronically retrieve the source document or a document identifier 146 (document reference) that can be used to retrieve the source document. In some embodiments, the document identifier 146 is stored in document index 150 while a static graphic representation 148 of the source document is stored in document repository 152. In some embodiments, the document identifier 146 and the static graphic representation 148 of each source document tracked by server 178 is stored in document index 150. In some embodiments, the document identifier 146 and the static graphic representation 148 of each source document tracked by server 178 is stored in document repository 152. It will be appreciated that the document identifiers 146 and the static graphic representations 148 may be stored in any number of different ways, either in the same data structure or in different data structures within server 178 or in computer readable memory or media that is accessible to server 178.

In some embodiments, vertical collections 144 are used. Vertical collections 140 are constructed using documents in document index 150 that pertain to a particular category. For example, one vertical collection 144 may be constructed from documents indexed by document index 150 that pertain to movies, another vertical collection 144 may be constructed from documents indexed by document index 150 that pertain to sports, and so forth. Vertical collections 144 can be constructed, merged, or split in a relatively straightforward manner. In some embodiments, there are hundreds of vertical collections 144 set up in this manner. In some embodiments, there are thousands of vertical collections 144 set up in this manner.

Once the document index 150 has been constructed, it is possible to construct the vertical index 138 in embodiments that make use of vertical collections. To accomplish this, in some embodiments, each vertical collection 450 is inverted. In some embodiments, each vertical collection 144 has the form:

Vertical collection (V₁)₁₄₄₋₁

DocId₁₄₆₋₁₋₁
Static Graphic DocId₁₄₈₋₁₋₁
Word Map DocId₁₆₈₋₁₋₁
DocId₁₄₆₋₁₋₂
Static Graphic DocId₁₄₈₋₁₋₂
Word Map DocId₁₆₈₋₁₋₂
.
.
.
DocId_{146-1-P}
Static Graphic DocId_{148-1-P}
Word Map DocId_{168-1-P}

In some embodiments, each DocId in the vertical collection 144 further includes a document quality score. Inversion of each of the vertical collections 144 and the merging of each of these inverted vertical collections leads to an inverted document-vertical index having the following data structure:

| Document | Associated vertical |
|---|---|
| identifiers | collections 144 |
| DocId₁₋₁ | Vₐ, . . . , Vₓ |
| DocId₁₋₂ | V_{b}, . . . , V_{y} |
| . | |
| . | |
| . | |
| DocId_{1-P} | V_{c}, . . . , V_{z} |
| DocId₂₋₁ | V_{d}, . . . , Vₐₐ |
| . | |
| . | |
| . | |

Thus, for each given document in document index 150, a list of vertical collections 144 associated with the given document can be obtained by taking the associated vertical collections for the given document from the inverted vertical collection. There can be several vertical collections 144 associated with any given document in this manner. Further, there is no requirement that each document be associated with a unique set of vertical collections 144.

Thus, as seen above, with the inverted document-vertical index, it is possible to create a vertical index 138 by substituting the document identifiers in document index 150 with the corresponding vertical collections associated with such document identifiers as set forth in the inverted document-vertical index. In one approach, this is done by scanning the document index 150 on a termwise basis, and collecting the set of vertical collections 144 that are associated with the documents that are, themselves, associated with each term as set forth in the inverted document-vertical index. For example, consider a term 1 in the exemplary document index 150 presented above. According to document index 150, term 1 is associated with docID₁ₐ, . . . , docID₁ₓ. Thus, for each respective docIDᵢ in the set docID₁ₐ, . . . , docID₁ₓ, the inverted document-vertical index is consulted to determine which vertical collections 144 are associated with the respective docIDᵢ. Each of these vertical collections 144 are then associated with term 1 in order to construct a vertical index list 140 for term 1. Thus, starting with the entry for term 1 in document index 150,

| | |
|---|---|
| term 1 | DocID₁ₐ, . . . , docID₁ₓ |

the set of vertical collections associated with docID₁ₐ, . . . , docID₁ₓ are collected from the inverted document-vertical index in order to construct the vertical index list 140:

| | |
|---|---|
| term 1 | V₁, V₂, . . . , V_{N} |

where each of V₁, V₂, . . . , V_{N} is a vertical collection identifier that points to a unique vertical collection 144. This data structure is a vertical index list 140. As illustrated, a vertical index list 140 is a list of vertical collection identifiers of vertical collections 144 sharing a definable attribute (e.g., “term 1”). If term 1 was “vacation,” than vertical index list 140 contains the identifiers of the vertical collections 144 holding documents containing the word “vacation.” The predicate defining the list, “term 1” in the above example, is referred to as the “head term.”

By considering all the terms in a collection of terms, vertical index 138 is constructed. There may be a large number of terms in the collection of terms. Vertical index 138 includes vertical index lists 140, along with an efficient process for locating and returning the vertical index list 140 corresponding to a given attribute (search term). For example, a vertical index 138 can be defined containing vertical index lists 140 for all the words appearing in a collection. Vertical index 138 stores, for each given word in the collection, a vertical index list 140 of those vertical collections 144. Each such vertical collection 144 in the vertical index list 140 for the given word holds at least some documents containing the given word.

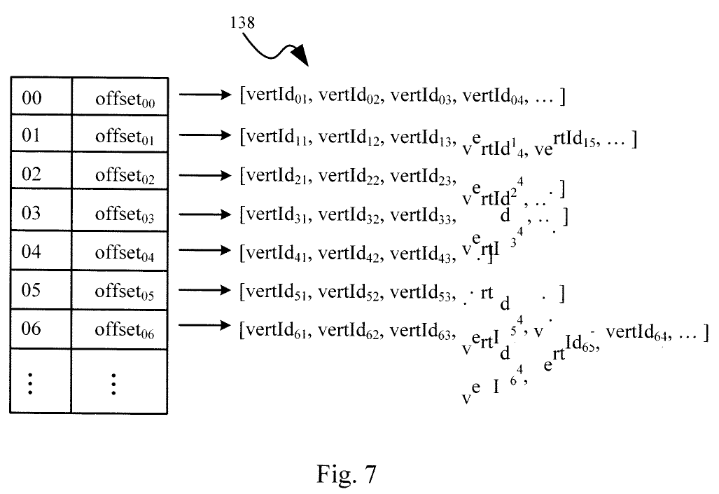

Referring to FIG. 7, a specific structure for vertical index 138 is provided in accordance with some embodiments. Vertical index 138 includes a hash lookup table and a vertical index list storage component. The hash lookup table contains pointers or file offsets that pinpoint the location of an individual vertical index list 140. A hash of a given head term (search term) provides the correct offset to corresponding list of vertical collections 144 that hold documents for the given head term. For example, consider the case in which the head term is “vacation.” The head term is hashed to give, in this example, the offset 03. A table lookup at offset 03 in vertical index 138 gives the list of identifiers {vertId₃₁, vertId₃₂, vertId₃₃, vertId₃₄, . . . } that correspond to the head term “vacation.” Each identifier in the set {vertId₃₁, vertId₃₂, vertId₃₃, vertId₃₄, . . . } corresponds to a vertical collection 144 that contains documents with the “vacation” head term. Continuing to refer to FIG. 7, the vertical index lists are shown as having different lengths because that is the usual case. In some embodiments, a term specific score is associated with each vertical identifier in each vertical index list.

Steps for constructing a vertical index 138 have been detailed above. The vertical index 138 includes, for each respective head term in a collection of head terms, the list of vertical collections 144 having documents that contain the respective head term. To optimize vertical index 138, additional steps are taken in some embodiments to rank each vertical collection 144 referenced in each respective vertical index list 140 so that only the most significant vertical collections 144 are returned for any given search query. Methods for ranking vertical collections are disclosed in United States Patent Publication Number 2007/0244863 which is hereby incorporated by reference herein in its entirety.

For further details on exemplary browser functionality that may be used to locate web pages or static graphic representations of web pages, see U.S. Patent Publication Nos. 2007/0244863 and 2007/0244862, the entire contents of each of which are hereby incorporated by reference herein; and U.S. patent application Ser. Nos. 11/983,629, 12/045,685, 12/045,691, and 12/045,696, the entire contents of each of which are hereby incorporated by reference herein.

### 6. Additional Embodiments

As illustrated in FIG. 5A, in some embodiments, one page 505 of an album 180 is displayed in center position 570 of a graphic output device 6. Moreover, additional pages in the album are displayed in off-center positions 580 of the graphic output device, where the pages are displayed rotated (e.g., at least one degree out of the plane of the graphic output device 6, at least two degrees out of the plane of the graphic output device 6, at least three degrees out of plane of the graphic output device 6, at least five degrees out of plane of the graphic output device 6) about a first axis of rotation 240 that lies between position 570 and the first off-center position 580 of the graphic output device. Note that the placement of positions 580 to the right of position 570 is merely exemplary and that positions 580 can in fact be at any position relative to position 570. Therefore, the position of the first axis of rotation 240 in FIG. 5A is merely exemplary.

In some embodiments, responsive to a selection of the page at position 580-1, the page at position 580-1 is shifted from the first off-center position 580-1 to the center position 570. Further, the page in the center position 570 in FIG. 5A is shifted to a second off-center position 590-1 of the graphic output device, thereby causing the page that was in center position 570 to now be displayed at the second off-center position 590-1 rotated (e.g., at least one degree out of the plane of the graphic output device 6, at least two degrees out of the plane of the graphic output device 6, at least three degrees out of plane of the graphic output device 6, at least five degrees out of plane of the graphic output device 6) about a second axis of rotation 242 that lies between the center position 570 and the second off-center position 590-1 of the graphic output device. As part of this action, the page occupying the first off-center position 580-1 in FIG. 5A is shifted to the center position (at position 570) of the graphic output device where it is now displayed in a manner that is no longer rotated about the first axis of rotation 240.

Just as pages can be shifted from the first off-center position 580, to the center position 570, and then to the second off-center position 590, the reverse is also true. When a user clicks on any page occupying the second off-center positions 590, the page occupying the second off-center position 590-1 is shifted to the center position 570 and the page formerly occupying the center position 570 is shifted to the first off-center position 580-1. Thus, in the above-identified manner, a user can easily view the pages of an album 180 in a seamless and efficient manner.

In some embodiments, responsive to a selection of the page occupying the center position 570 of the graphic output device 6, the size of the page is enlarged. For instance, in some embodiments, the page is enlarged by at least 10 percent, at least 20 percent, at least 30 percent, or at least 100 percent. Furthermore, responsive to a selection of a portion of the graphic output device 6 outside of the page occupying the center position 570 while it is in its enlarged state, the size of the page is reduced back to the original size that it was before it was enlarged.

In some embodiments, responsive to a selection of the page occupying the center position 570, a web page impression from the source document of the page is retrieved. In other words, a “live” version of the document obtained from the URL or other address where the document corresponding to the page was found is obtained and used to replace the page.

As illustrated in FIG. 5A, in some instances, a toggle bar 592 is provided. When the user pulls the toggle bar 592 in a first direction (e.g., from right to left), the pages shift from the first off-center positions 580 to the center position 570, and from the center position 570 to the second off-center positions 590 responsive to the pull in the first direction. When the search requester pulls the toggle bar in a second direction (e.g., from right to left), the pages shift from the second off-center position 590-1 to the center position 570, and from the center position 570 to the first off-center position 580 responsive to the pull in the second direction.

Referring to FIG. 5A, it will be understood that when a page moves from position 580-1 to position 570, that all pages at positions 580-(X) move to positions 580-(X−1), that when a page moves from position 570 to 580-1, that all pages at positions 580-(X) move to positions 580-(X+1) in some embodiments. It will be further understood that when a page moves from position 570 to position 590-1, that all pages at positions 590-(X) move to positions 590-(X+1), that when a page moves from position 590-1 to position 570, that all pages at positions 590-(X) move to positions 580-(X−1) in some embodiments.

Referring to FIGS. 1A through 1D, an embodiment comprises a computer 178 having one or more processors 102 and a memory (114/120). The computer further comprises instructions, wherein the instructions are stored in the memory (114/120) and are executed by the one or more processors 102.

The instructions comprise instructions for accessing a document repository 152 comprising a plurality of documents. The document repository 152 can be stored by computer 178 and/or accessible to the computer over network 126.

The instructions further comprise instructions for accessing an album repository 154 comprising a plurality of albums 154. The album repository can be stored by computer 178 and/or accessible to the album repository 154 over network 126. Each album 178 in the plurality of albums comprises a plurality of links 198. A first link in the plurality of links in a respective album 180 in the plurality of albums uniquely identifies and localizes a first document in the plurality of documents in the document repository 152. That is, by using the first link the first document in the document repository 152 can be localized.

The instructions further comprise instructions for accessing a display module 36 on a first remote computer 100, wherein the display module 36 comprises (i) instructions for using one or more links 196 in the plurality of links in a respective album 180 in the plurality of albums to obtain a corresponding two or more documents in the plurality of documents in the document repository 152 and (ii) instructions for displaying the contents of the two or more documents, and wherein the first remote computer 100 is in electronic communication with the memory (114/120) of the computer 178.

The instructions further comprise instructions for implementing an interactive method. The interactive method comprises receiving a first request, from a remote second computer, for the first document in the plurality of documents in the document repository 152, where the second remote computer is in electronic communication with the memory (114/120) of the computer 100. This remote second computer can be another instance of a computer 100 illustrated in FIG. 1C. As indicated above, in typical embodiments there are many computers 100, each of which is in electronic communication with the computer 100. Thus the “first remote computer” and the “second remote computer” can be any pair of remote computers 100. Response to the first request, the first document is sent to the second remote computer. Then, a second request is received by computer 178 from the second remote computer, after the first request, to add the link to the first document to a first album 180 in the plurality of albums. The link to the first document is stored in the first album 180 in the album repository 154 in response to the second request. A third request is received by the computer 178 from the second remote computer to share the first album with an album recipient associated with the first remote computer. Computer readable instructions based on the content of the first album (e.g., content such as illustrated in FIG. 3 and/or an album icon 192 of FIG. 1D) is sent to the first remote computer from the computer 178 in response to the third request. The computer readable instructions are configured to be parsed by the first remote computer so that the display module 36 (typically operating in conjunction with web browser 34) on the first remote computer can display the contents of two or more documents in the document repository 152 that are linked to the first album.

In some embodiments, the first document in the plurality of documents in the document repository 152 is a static graphic representation of a web page. In some embodiments, the first album further comprises an access privilege 184 and the sending comprises determining whether the album recipient has access privileges to the first album 180, wherein, (a) when the album recipient has access privileges, the computer readable instructions based on the content of the first album are sent to the first remote computer in response to the third request, and (b) when the album recipient does not have access privileges, the computer readable instructions based on the content of the first album are not sent to the first remote computer in response to the third request. In some embodiments, the first album further comprises an edit history and wherein the storing comprises updating the edit history to reflect when the link to the first document is stored in the first album.

In some embodiments, the first document in the plurality of documents in the document repository has been categorized by a classifier into a category and the category of the first document is stored with the first document in the document repository (e.g., as a characterization of a link 198).

In some embodiments, the computer 178 further comprises instructions for accessing an advertisement repository 156 comprising a plurality of advertisements. The advertisement repository 156 can be stored on the computer 178 or be accessible by the computer 178. In some such embodiments, the above-described storing of a first album comprises storing a link in the first album to an advertisement in the advertisement repository 156 that is selected from the plurality of advertisements based on a category of the first document. In some embodiments, this link to the advertisement is sent to the first remote computer as part of the computer readable instructions in the above-described sending step. In some embodiments the advertisement is an image or an interactive form.

In some embodiments, the computer 178 further comprises instructions for accessing an advertisement repository 156 comprising a plurality of advertisements. The advertisement repository 156 can be stored on the computer 178 or be accessible by the computer 178. In some such embodiments, the above-described storing of a first album comprises storing in the first album an advertisement in the advertisement repository 156 that is selected from the plurality of advertisements based on a category of the first document. In some embodiments, this advertisement is sent to the first remote computer as part of the computer readable instructions in the above-described sending step. In some embodiments the advertisement is an image or an interactive form.

In some embodiments, the document repository referenced above is not the document repository 152 but rather is, in fact, a vertical collection 144 and the category of the first document is the category associated with the vertical collection 144. In some embodiments, the first document is a web page and the link to the first document that is stored in the first alum is a uniform resource location of the web page in the Internet.

In some embodiments, the computer readable instructions sent to the first remote computer comprise an album icon 192 that links to the first album in the album repository 154, wherein the album icon is stored in the first album in the album repository. Further, the computer 178 comprises, in such embodiments, instructions for receiving a fourth request from the album recipient to review the first album after the album icon was sent to the first remote computer and instructions for sending each link in the plurality of links in the first album to the first remote computer for display by the display module 36 (typically in conjunction with web browser 34) in response to the fourth request. In some embodiments, the computer readable instructions sent to the first remote computer further comprises a sound effect 194 stored in a computer readable sound effect file that is configured to be played on the first remote computer, where the computer readable sound effect file is stored in the first album in the album repository.

In some embodiments, the first album in the album repository 154 further comprises an album classification 182. The album classification of the first album can be derived from a classification (characterization) 198 of one or more documents in the document repository 152 that are linked to the first album by the plurality of links 196 in the first album. In some such embodiments, the computer 178 further comprises instructions for accessing an advertisement repository 156 comprising a plurality of advertisements. Further, the above-described storing step comprises storing a link in the first album to an advertisement in the advertisement repository 156 that is selected from the plurality of advertisements based on the classification of the first album and the computer readable instructions sent to the first remote computer comprise the link to the advertisement. In some embodiments the advertisement is an image or an interactive form.

In some embodiments, the first album in the album repository 154 further comprises an album classification 182. The album classification of the first album can be derived from a classification (characterization) 198 of one or more documents in the document repository 152 that are linked to the first album by the plurality of links 196 in the first album. In some such embodiments, the computer 178 further comprises instructions for accessing an advertisement repository 156 comprising a plurality of advertisements. Further, the above-described storing step comprises storing in the first album an advertisement in the advertisement repository 156 that is selected from the plurality of advertisements based on the classification of the first album and the computer readable instructions sent to the first remote computer comprise the link to the advertisement. In some embodiments the advertisement is an image or an interactive form.

Another aspect of the invention provides a method comprising receiving a first request, from a remote first computer, for a first document in a plurality of documents in a document repository. The first document is obtained from the document repository. The first document is sent to the first remote computer, in response to the first request. A second request is received from the first remote computer, after the first request, to add a link to the first document to a first album in a plurality of albums in an album repository. The link to the first document is stored in the first album in the album repository in response to the second request, where each album in the plurality of albums in the album repository comprises a plurality of links, and where the first link in the first album uniquely identifies and localizes the first document in the document repository. A third request is received from the first remote computer to share the first album with an album recipient associated with a second remote computer. Computer readable instructions based on the content of the first album stored in the album repository are sent to the second remote computer in response to the third request, where the computer readable instructions are configured to be parsed by the second remote computer so that a display module on the second remote computer can display the contents of two or more documents in the document repository that are linked to the first album. In some embodiments, the first document is a static graphic representation of a web page obtained from the Internet during a web crawl.

In some embodiments the first album further comprises an access privilege 184 and the sending comprises determining whether the album recipient has access privileges to first album, where (a) when the album recipient has access privileges, the computer readable instructions based on the content of the first album are sent to the second remote computer in response to the third request and (b) when the album recipient does not have access privileges, the computer readable instructions based on the content of the first album are not sent to the second remote computer in response to the third request.

In some embodiments, the first album further comprises an edit history and the storing comprises updating the edit history to reflect when the link to the first document is stored in the first album. In some embodiments, the first document in the plurality of documents in the document repository has been categorized by a classifier into a category and the category of the first document is stored with the first document in the document repository. In such embodiments the storing comprises storing the category of the first document with the link to the first document in the first album. In some embodiments, the storing comprises storing a link to an advertisement in an advertisement repository, which is selected from a plurality of advertisements in the advertisement repository based on a category of the first document, in the first album. In such embodiments, the computer readable instructions further comprise the link to the advertisement. In some embodiments the storing comprises storing an advertisement in an advertisement repository, which is selected from a plurality of advertisements in the advertisement repository based on a classification of the first album, in the first album and the computer readable instructions in the sending step further comprise the advertisement. In some embodiments, the advertisement is an image or an interactive form.

Under another aspect, a method for building an album includes: obtaining a plurality of documents from a remotely located document repository; displaying a first document in the plurality of documents in a center position of a graphic output device; displaying a second document in the plurality of documents in a first off-center position of the graphic output device; wherein the second document is displayed rotated about a first axis of rotation that lies between the center position and the first off-center position of the graphic output device; accepting user input to add a link to the document in the remotely located document repository to said album; and storing said album in a remotely located album repository.

In some embodiments, said user input includes a user gesture moving the first document to a predetermined area in the graphic output device. Some embodiments further include, responsive to a selection of the second document in the first off-center position, the steps of: shifting the first document to a second off-center position of the graphic output device; thereby causing the second document to be displayed at the second off-center position rotated about a second axis of rotation that lies between the center position and the second off-center position of the graphic output device; shifting the second document to the center position of the graphic output device; thereby causing the second document to be displayed at the center position in a manner that is no longer rotated about the first axis of rotation; and displaying the a third document in the first off-center position of the graphic output device; wherein the third document is displayed rotated about the first axis of rotation. Some embodiments further include, responsive to a selection of the first document in the second off-center position, the steps of: shifting the first document to the center position of the graphic output device; thereby causing the first document to be displayed at the center position in a manner that is no longer rotated about the second axis of rotation; and shifting the second document to the first off-center position; thereby causing the second document to be displayed at the first off-center position in a manner that is rotated about the first axis of rotation. Some embodiments further include, responsive to a selection of the first document in said center position of the graphic output device, the step of enlarging a size of the first document. Some embodiments further include, responsive to a selection of a portion of the graphic output device outside of the first document when the first document is displayed in an enlarged state, the step of reducing a size of the displayed first document to an original size.

In some embodiments, the first document is a static graphic representation of a web page on the Internet, the method further including, responsive to a selection of the first document, and the method further includes the steps of: retrieving a web page impression of the web page corresponding to the first document; and replacing the displayed first document with the web page impression. Some embodiments further include, responsive to a selection of the first document in the center position of the graphic output device, the step of flipping the first document from a first side to a reverse side so that the reverse side of the document is shown. In some embodiments, the reverse side of the first document contains information associated with the first document.

Some embodiments further include providing a toggle bar on the graphic output device, wherein, when the toggle bar is pulled in a first direction, displayed documents in the first plurality of documents shift from the first off-center position to the center position, and from the center position to a second off-center position responsive to the pull in the first direction; and when the toggle bar is pulled in a second direction, displayed documents in the first plurality of search results shift from the second off-center position to the center position, and from the center position to the first off-center position responsive to the pull in the second direction.

Some embodiments further include embedding an advertisement into the album based on a characterization of the first document. In some embodiments, each document in the plurality of documents belongs to one or more categories and wherein the accepting further includes associating the category of the document with the link when the link is added to the album. In some embodiments, each document in the plurality of documents is a static graphic representation of an entire web page that was rendered at a time before the obtaining step. In some embodiments, each document in the first plurality of documents is from a vertical index. Some embodiments further include, prior to the obtaining, submitting a search query to a search engine server, wherein the plurality of documents are documents obtained as search results from the search engine server. Some embodiments further include accepting user input regarding a category of the album to which the link to the first document is added. Some embodiments further include automatically selecting a category of the album to which the link to the first document is added. In some embodiments, the category is automatically selected based on a vertical collection to which the first document belongs.

In some embodiments, the album is created when the first document is added to the album. In some embodiments, the album includes a markup language document. In some embodiments, the markup language document includes an entry for each document linked to the album, each entry including a link for the corresponding document. In some embodiments, said user input includes one of: selection of a button, entering of a predetermined keystroke, or a drag and drop gesture. Some embodiments further include displaying a plurality of album buttons representing different albums in a plurality of albums, each album in the plurality of albums including a plurality of links stored in a remote document repository or one or more remote vertical collections, and wherein said user input includes a selection of one album button of the plurality of album buttons. In some embodiments, the first document is one web page of a plurality of web pages obtained as a result of a web search. In some embodiments, the first document is one static graphic representation of a web page of a plurality of static graphic representations of web pages obtained as a result of a web search. Some embodiments further include electronically sharing said album with a recipient associated with a remote computer.

Under another aspect, a computer program product for use in conjunction with a computer system includes a computer readable storage medium and a computer program mechanism embedded therein, the computer program mechanism including: instructions for obtaining a plurality of documents from a remotely located document repository; instructions for displaying a first document in the plurality of documents in a center position of a graphic output device; instructions for displaying a second document in the plurality of documents in a first off-center position of the graphic output device; wherein the second document is displayed rotated about a first axis of rotation that lies between the center position and the first off-center position of the graphic output device; instructions for accepting user input to add a link to the document in the remotely located document repository to said album; and instructions for storing said album in a remotely located album repository. In some embodiments, said user input includes a gesture dragging the first document to a predetermined area in the graphic output device.

Under another aspect, a computer includes a main memory; one or more processors; and one or more programs, stored in the main memory and executed by the one or more processors, the programs collecting including instructions for: obtaining a plurality of documents from a remotely located document repository; displaying a first document in the plurality of documents in a center position of a graphic output device; displaying a second document in the plurality of documents in a first off-center position of the graphic output device; wherein the second document is displayed rotated about a first axis of rotation that lies between the center position and the first off-center position of the graphic output device; accepting user input to add a link to the document in the remotely located document repository to said album; and storing said album in a remotely located album repository. In some embodiments, said user input includes a gesture moving the first document to a predetermined area in the graphic output device.

### 7. Incorporated References

All references cited herein are incorporated herein by reference in their entirety and for all purposes to the same extent as if each individual publication or patent or patent application was specifically and individually indicated to be incorporated by reference in its entirety for all purposes.

### 8. Alternative Embodiments

The systems and methods described herein can be implemented as a computer program product that includes a computer program mechanism embedded in a computer readable storage medium. For example, the computer program product can contain the program modules shown in FIGS. 1B-1C. These program modules can be stored on a CD-ROM, DVD, magnetic disk storage product, or any other computer readable data or program storage product. The software modules in the computer program can also be distributed electronically, via the Internet or otherwise, by transmission of a computer data signal (in which the software modules are embedded).

Although the above-described embodiments include albums in which static rendered images of web pages are displayed, and in which a user can access a “live” version of a web page by selecting its corresponding image, in other embodiments the albums directly include live versions of web pages.

Many modifications and variations of this invention can be made without departing from its spirit and scope, as will be apparent to those skilled in the art. The specific embodiments described herein are offered by way of example only. The embodiments were chosen and described in order to explain the principles of the invention and its practical applications, to thereby enable others skilled in the art to utilize the invention and various embodiments with various modifications as are suited to the particular use contemplated. The invention is to be limited only by the terms of the appended claims, along with the full scope of equivalents to which such claims are entitled.

What is claimed:

1. A method of displaying information, the method comprising:
obtaining, responsive to a user query, an album from a remote computer, wherein
the album comprises a plurality of links,
each link in the plurality of links is to a static graphic representation in a plurality of static graphic representations,
each static graphic representation in the plurality of static graphic representations is stored in a document repository in a remote location;
each static graphic representation in the plurality of static graphic representations is a static graphic representation of a document retrieved from the Internet at a time before the obtaining;
getting, responsive to said user query, a subset or all of the static graphic representations in the plurality of static graphic representations using a corresponding subset or all of links in the plurality of links, wherein the subset or all of the static graphic representations in the album is at least two static graphic representations in the album; and
displaying the subset of static representations on a graphic output device.

2. The method of claim 1, wherein the displaying further comprises displaying the subset of static graphic representations in an order specified by the album.

3. The method of claim 1, wherein the user query identifies the album from among a plurality of albums.

4. The method of claim 1, wherein the user query is one of: an email including a link identifying the album, a user clicking on a link in a web page, the link identifying the album.

5. The method of claim 1, wherein the displaying comprises
displaying a first static graphic representation of a first document at a center position of the graphic output device, and
displaying a second static graphic representation of a second document at an off-center position of the graphic output device, wherein the second static graphic representation is displayed rotated about a first axis of rotation that lies between the center position and the off-center position of the graphic output device.

6. The method of claim 5, further comprising receiving user input shifting the second static graphic representation to the center position of the graphic output device.

7. The method of claim 1, wherein
each document in the plurality of documents is a web page obtained from the Internet before the obtaining,
each static graphic representation in the plurality of static graphic representations includes a link to the corresponding document in the plurality of documents,
the displaying further comprises displaying a live version of a web page corresponding to a displayed static graphic representation in the displayed subset of static graphic representations, responsive to a user selection of the static graphic representation that corresponds to the web page.

8. The method of claim 1, wherein the album comprises a markup language file.

9. The method of claim 8, wherein the markup language file comprises an entry for each link in the plurality of links.

10. A computer program product for use in conjunction with a computer system, the computer program product comprising a computer readable storage medium and a computer program mechanism embedded therein, the computer program mechanism comprising:
instructions for obtaining, responsive to a user query, an album from a remote computer, wherein
the album comprises a plurality of links,
each link in the plurality of links is to a static graphic representation in a plurality of static graphic representations,
each static graphic representation in the plurality of static graphic representations is stored in a document repository in a remote location;
each static graphic representation in the plurality of static graphic representations is a static graphic representation of a document retrieved from the Internet at a time before the obtaining;
instructions for getting, responsive to said user query, a subset or all of the static graphic representations in the plurality of static graphic representations using a corresponding subset or all of the links in the plurality of links, wherein the subset or all of the static graphic representations in the album is at least two static graphic representations in the album; and
instructions for displaying the subset of static representations on a graphic output device.

11. A computer, comprising:
a main memory;
one or more processors; and
one or more programs, stored in the main memory and executed by the one or more processors, the one or more programs collectively including instructions for:
obtaining, responsive to a user query, an album from a remote computer, wherein
the album comprises a plurality of links,
each link in the plurality of links is to a static graphic representation in a plurality of static graphic representations,
each static graphic representation in the plurality of static graphic representations is stored in a document repository in a remote location;
each static graphic representation in the plurality of static graphic representations is a static graphic representation of a document retrieved from the Internet at a time before the obtaining;
getting, responsive to said user query, a subset or all of the static graphic representations in the plurality of static graphic representations using a corresponding subset or all of links in the plurality of links, wherein the subset or all of the static graphic representations in the album is at least two static graphic representations in the album; and
displaying the subset of static representations on a graphic output device.

12. A method of sharing information about a plurality of web pages, the method comprising:
obtaining an album, the album including links to a plurality of web pages;
transmitting the album to a second user in response to input from a first user; and
performing the method, responsive to input from the second user, comprising:
obtaining a static graphic representation of each web page in the plurality of web pages in the album, thereby retrieving a plurality of static graphic representations, wherein the plurality of static graphic representations were rendered from said corresponding plurality of web pages at a time before the obtaining; and
displaying the plurality of static graphic representations on a graphic output device.

13. The method of claim 12, wherein transmitting comprises:
generating a computer-readable link to a location of the album on a remote computer; and
electronically communicating the computer readable link to the location of the album to the second user.

14. The method of claim 13, further comprising:
generating an icon representative of the album; and
associating the computer-readable link with the icon such that each static graphic representation linked by the album is displayed on the graphic output device responsive to user selection of the icon.

15. The method of claim 14, wherein the electronically communicating comprises emailing the computer readable link to the album to the second user.

16. The method of claim 14, wherein the electronically communicating comprises posting the computer readable link to the album on a web site that is accessible to the second user.

17. The method of claim 12, wherein the album is modifiable by the second user.

18. The method of claim 12, wherein the album comprises a markup language document.

19. The method of claim 18, wherein the markup language document comprises an entry for each web page referred to in the album, each entry comprising an Internet address for the corresponding web page.

20. A computer program product for use in conjunction with a computer system, the computer program product comprising a computer readable storage medium and a computer program mechanism embedded therein, the computer program mechanism comprising:
instructions for obtaining an album, the album including links to a plurality of web pages;
instructions for transmitting the album to a second user in response to input from a first user; and
instructions for performing the method, responsive to input from the second user, comprising:
obtaining a static graphic representation of each web page in the plurality of web pages in the album, thereby retrieving a plurality of static graphic representations, wherein the plurality of static graphic representations were rendered from said corresponding plurality of web pages at a time before the obtaining; and
displaying the plurality of static graphic representations on a graphic output device.

21. A computer, comprising:
a main memory;
one or more processors; and
one or more programs, stored in the main memory and executed by the one or more processors, the one or more programs collectively including instructions for:
obtaining an album, the album including links to a plurality of web pages;
transmitting the album to a second user in response to input from a first user; and
performing the method, responsive to input from the second user, comprising:
obtaining a static graphic representation of each web page in the plurality of web pages in the album, thereby retrieving a plurality of static graphic representations, wherein the plurality of static graphic representations were rendered from said corresponding plurality of web pages at a time before the obtaining; and
displaying the plurality of static graphic representations on a graphic output device.
